(19) United States
(12) Patent Application Publication
(10) Pub. No.: US 2026/0112268 A1
(43) Pub. Date: Apr. 23, 2026

(54) VEHICLE-ROAD COLLABORATIVE CONTROL ARCHITECTURE SYSTEM BASED ON DATAMECHANISM COUPLED MODELING AND CONSTRUCTION METHOD THEREOF

(71) Applicant: Jiangsu University, Zhenjiang, Jiangsu (CN)

(72) Inventors: Yingfeng CAI, Zhenjiang, Jiangsu (CN); Sikai LU, Zhenjiang, Jiangsu (CN); Tao JIANG, Zhenjiang, Jiangsu (CN); Zhaozhi DONG, Zhenjiang, Jiangsu (CN); Long CHEN, Zhenjiang, Jiangsu (CN); Hai WANG, Zhenjiang, Jiangsu (CN); Yicheng LI, Zhenjiang, Jiangsu (CN); Qingchao LIU, Zhenjiang, Jiangsu (CN)

(21) Appl. No.: 19/137,311

(22) PCT Filed: May 11, 2024
(86) PCT No.: PCT/CN2024/092573

§ 371 Date: Jun. 10, 2025

(30) Foreign Application Priority Data
Apr. 23, 2024 (CN) 202410491758.3

(51) Int. Cl. G08G 1/0967; G08G 1/16

(52) U.S. Cl. CPC G08G 1/096783; G08G 1/096725; G08G 1/166

(57) ABSTRACT

The present disclosure provides a vehicle-road collaborative control architecture system based on data-mechanism coupled modeling and a construction method. Aiming to solve the problem of high difficulty in traditional mechanism modeling for autonomous driving, the present disclosure proposes data-mechanism fusion-driven multi-agent system modeling, and a vehicle-road collaborative group optimization method based on federated reinforcement learning, and constructs a vehicle decision-making model parameter update technology based on multi-dimensional experience sharing. Thus, the present disclosure solves the explainability and generalization problems of purely data-driven models. The present disclosure constructs a rule-based traffic safety field and achieves rule-guided data-driven training. The present disclosure constructs an intelligent chassis-based secondary planning control framework, and proposes a chassis feedback-based state quantity input. Thus, the present disclosure solves problems of purely data-driven methods, including questionable trustworthiness, reliance on large-scale data, and opaque and unexplainable decision-making processes.

### TECHNICAL FIELD

The present disclosure belongs to the field of transportation, and relates to a vehicle-road collaborative control architecture system based on data-mechanism coupled modeling and a construction method thereof.

### BACKGROUND

In the field of autonomous driving, current systems are large-scale cyber-physical systems, and achieving high-level autonomous driving through traditional mechanism modeling methods poses significant challenges. The limitations of these traditional methods are manifested in constrained environmental perception, difficulties in interaction modeling and scene understanding, inefficient decision-making and planning, and inadequate assurance of driving safety. These limitations directly restrict the application of autonomous driving technology in complex traffic scenarios.

In the application process, the main challenges of autonomous driving algorithms can be summarized as the trustworthiness issue and the explainability issue. For the trustworthiness issue, the rule-based methods heavily rely on handcrafted rules, making them hard to adapt to complex driving environments. Conversely, the end-to-end data-driven methods excessively depend on training samples, and insufficient training for long-tail cases may lead to severe decision-making errors, directly causing concerns about the algorithm's trustworthiness in applications. Regarding the explainability issue, the opaque structure of black-box algorithms leads to insufficient explainability of data-driven methods, thereby failing to explain the control processes and decision-making criterion. Meanwhile, the lack of explanations in the control algorithms directly hinders algorithm evaluation and improvement, further diminishing algorithmic trustworthiness.

Introducing federated learning to address the control algorithms' trustworthiness issue represents a novel approach. By transmitting and aggregating model parameters, this approach enhances algorithmic migration performance and robustness, thereby alleviating the control algorithms' trust crisis. However, the parameter aggregation process of federated learning inherently lacks explainability, which could offset the potential benefits of federated learning. In conclusion, existing autonomous driving algorithms face challenges in balancing algorithmic trustworthiness and explainability.

### SUMMARY

To solve the above technical problems, the present disclosure provides a vehicle-road collaborative control architecture based on data-mechanism coupled modeling. The present disclosure proposes a data-mechanism fusion-driven multi-agent system modeling method, and a vehicle-road collaborative group optimization method based on federated reinforcement learning, and constructs a vehicle decision-making model parameter update technology based on multi-dimensional experience sharing. The present disclosure solves the problems of explainability and generalization of purely data-driven models. The present disclosure solves the explainability and generalization problems of purely data-driven models. The present disclosure utilizes road side advantages to build a rule-based traffic safety field and achieves rule-guided data-driven training. The present disclosure proposes a data-mechanism coupled driving model to address the difficulty of traditional mechanism modeling in autonomous driving, constructs an intelligent chassis-based secondary planning control framework, and innovatively proposes a chassis feedback-based state quantity input. Thus, the present disclosure solves problems of purely data-driven methods, including questionable trustworthiness, reliance on large-scale data, and opaque and unexplainable decision-making processes. The present disclosure constructs a comfort quantification index for selecting locally optimal strategies for current environments by introducing weighted lateral acceleration, yaw angular acceleration, and longitudinal acceleration based on human perception sensitivity intervals. The present disclosure achieves a balance between sample efficiency and model robustness by synthesizing globally shared models benefiting from different environments.

In the present disclosure, a technical solution of the vehicle-road collaborative control architecture based on data-mechanism coupled modeling includes three components: a rule-guided coupled modeling component, a data-mechanism coupled planning control component, and a data-mechanism coupled evaluation component

The rule-guided coupled modeling component is configured to: process bird's-eye view information by a road side to construct a traffic safety field, and provide guidance for a data-driven control algorithm training process by constructing a fused reward function. The coupled modeling component includes three modules: a road side information processing module, a safety field modeling module, and a reward function modeling module.

The road side information processing module is configured to: utilize a field-of-view advantage of the road side to convert an image under a bird's-eye view into a semantic bird's-eye view, model an interaction between intelligent connected vehicles at the road side through dynamic information in the semantic bird's-eye view, and transmit safety field information and the semantic bird's-eye view to a vehicle side via V2I communication. The semantic bird's-eye view is a 4-channel matrix, including static road information and lane line information, along with dynamic desired route information and vehicle information.

The safety field modeling module is configured to construct the safety field according to following equations:

$$\begin{matrix}{S}_{sta} = {C}_{a} \cdot exp ( - \frac{{( x - {x}_{0} )}^{2}}{{a}_{x}^{2}} - \frac{{( y - {y}_{0} )}^{2}}{{b}_{y}^{2}} ) \\ ε = \frac{{a}_{x}^{2} - {b}_{y}^{2}}{{a}_{x}^{2} + {b}_{y}^{2}} = \frac{{ϕ}^{2} - 1}{{ϕ}^{2} + 1} \\ ϕ = {a}_{x} / {b}_{y} = {l}_{v} / {w}_{v}\end{matrix}$$

where, Sₛₜₐ denotes a static safety field intensity; Cₐ denotes a static safety field intensity coefficient; x₀ and y₀ denote coordinates of a static risk center O(x₀, y₀); ε denotes a safety field shape coefficient; aₓ and b_{y} denote appearance coefficients of the intelligent connected vehicles; φ denotes a length-width ratio of the intelligent connected vehicles; lᵥ denotes a vehicle length; and wᵥ denotes a vehicle width.

When the intelligent connected vehicle moves, a risk center O(x₀, y₀) of a Gaussian safety field shifts with vehicle movement to form a new risk center

$${O}^{′} ( {x}_{0}^{′} , {y}_{0}^{′} ) : \{ \begin{matrix}{x}_{0}^{′} = {x}_{0} + {k}_{v} \vert \vec{v} \vert cos β \\ {y}_{0}^{′} = {y}_{0} + {k}_{v} \vert \vec{v} \vert sin β\end{matrix}$$

$${S}_{d y n} = {C}_{a} \cdot exp ( - \frac{{( x - {x}_{0}^{′} )}^{2}}{{( {a}_{x}^{′} )}^{2}} - \frac{{( y - {y}_{0}^{′} )}^{2}}{{( {b}_{y}^{′} )}^{2}} )$$

where, kᵥ denotes a movement adjustment factor, kᵥ [symbol] {(−1,0)∪(0,1)}, with a sign correlated with a movement direction; β denotes an angle between a shift vector kᵥ|\vec{v}| of the intelligent connected vehicles and a coordinate axis in a Cartesian system; \vec{v} denotes a velocity vector of the intelligent connected vehicle; a virtual vehicle with a length of

$${l}_{v}^{′}$$

and a width of

$${w}_{v}^{′}$$

is formed in a dynamic safety field under shifting of the risk center; S_{dyn} denotes a dynamic safety field intensity, and a new length-width ratio is denoted as

$${ϕ}^{′} = {a}_{x}^{′} / {b}_{y}^{′} = {l}_{v}^{′} / {w}_{v}^{′} .$$

The reward function modeling module considers two aspects: driving expectation and driving safety:

$$r = {r}_{expectation} + {r}_{safety}$$

where, r denotes the reward function; r_{expectation} denotes a driving expectation-related reward function; and r_{safety} denotes a driving safety-related reward function.

The driving expectation-related reward function includes two aspects: lateral and longitudinal; and for a lateral driving expectation:

$$\begin{matrix}{d 0 = min ( \vert \vert {a}_{28 , 28} - {b}_{desired route} \vert \vert}^{2} ) \\ r {1}_{lateral} = - {log}_{1.1} ( \vert d 0 \vert + 1 ) \\ r {2}_{lateral} = - 10 * \vert sin ( radians ( θ ) ) \vert \\ {r}_{lateral} = r {1}_{lateral} + r {2}_{lateral}\end{matrix}$$

where, d0 denotes a distance from a lane centerline; a_{28,28} denotes an ego-vehicle center; b_{desired route} denotes a desired route; r1ₗₐₜₑᵣₐₗ denotes a lateral distance reward function; r2ₗₐₜₑᵣₐₗ denotes a heading angle reward function; θ denotes an vehicle side heading angle deviation; and rₗₐₜₑᵣₐₗ denotes a lateral driving expectation reward function.

For a longitudinal driving expectation:

$$\begin{matrix}{{d}_{min} = min ( \vert \vert {a}_{28 , 28} - {b}_{x , y} \vert \vert}^{2} ) \\ x = \{ \begin{matrix}\frac{{d}_{min}}{{v}_{ego}} , & if {d}_{min} \leq 14 \\ 1 , & if {d}_{min} > 14\end{matrix} \\ r {1}_{longitudinal} = - 5 + \sqrt{{5}^{2} ( 1 - {( x - 1 )}^{2} )} \\ r {2}_{longitudinal} = - \vert {v}_{e g o} - 9 \vert \\ {r}_{longitudinal} = r {1}_{longitudinal} + r {2}_{longitudnal}\end{matrix}$$

where, dₘᵢₙ denotes a minimum distance between autonomous vehicles; b_{x,y} denotes a surrounding-vehicle center, x denotes a collision time; v_{ego} denotes an ego-vehicle velocity; r1_{longitudinal} denotes a distance reward function; r2_{longitudinal} denotes a velocity reward function; and r_{longitudinal} denotes a longitudinal driving expectation reward function.

The driving expectation-related reward function is constructed according to the following equation:

$${r}_{expectation} = {r}_{lateral} + {r}_{longitudinal}$$

The driving safety-related reward function is calculated from two aspects of the traffic safety field of the road side: traffic safety and traffic aggressiveness; and for the traffic safety:

$$\begin{matrix}{R}_{i , j} ( t ) = \vert {\vec{S}}_{i , j} ( t ) \vert exp ( - {k}_{c} \vert {\vec{V}}_{j} ( t ) \vert cos {θ}_{i , j} ( t ) ) \\ {r}_{Risk} = \{ \begin{matrix}{f}_{Risk} ( ξ ) = {\sum }_{j \neq i} {\sum }_{t} [ {R}_{i , j} ( t ) - {R}_{thr} ] {τ}_{rc} \\ ∀ {R}_{i , j} ( t ) ⩾ {R}_{thr}\end{matrix}\end{matrix}$$

where, R_{i,j}(t) denotes a traffic risk caused by an intelligent connected vehicle j toward an intelligent connected vehicle i; |\vec{S}_{i,j}(t)| denotes a field intensity of the intelligent connected vehicle j toward the intelligent connected vehicle i; k_{c} denotes a risk perception coefficient; |\vec{V}ⱼ(t)| denotes a velocity of the intelligent connected vehicle j at a time t; θ_{i,j}(t) denotes a driving angle between the intelligent connected vehicle i and the intelligent connected vehicle j at the time t; r_{Risk} denotes a traffic risk-related reward function; ƒ_{Risk}(ξ) denotes a traffic risk integral; Rₜₕᵣ denotes a risk threshold; and τ_{rc} denotes a duration exceeding the risk threshold, and for the traffic aggressiveness:

$$\begin{matrix}{R}_{j , i} ( {t}^{′} ) = \vert {\vec{S}}_{j , i} ( {t}^{′} ) \vert exp ( - {k}_{c} \vert \vec{{V}_{i}} ( {t}^{′} ) \vert cos {θ}_{j , i} ( {t}^{′} ) ) \\ {r}_{Agg} = \{ \begin{matrix}{f}_{Agg} ( ξ ) = {\sum }_{j \neq i} {\sum }_{{t}^{′}} [ {R}_{j , i} ( {t}^{′} ) - {R}_{thr} ] {τ}_{rc} \\ ∀ {R}_{j , i} ( {t}^{′} ) ⩾ {R}_{thr}\end{matrix}\end{matrix}$$

where, R_{j,i}(t′) denotes a traffic risk caused by the intelligent connected vehicle i toward the intelligent connected vehicle j; |\vec{S}_{j,i}(t′)| denotes a field intensity of the intelligent connected vehicle i toward the intelligent connected vehicle j; |\vec{V}ᵢ(t′)| denotes a velocity of the intelligent connected vehicle i at a time t′; θ_{j,i}(t′) denotes a driving angle between the intelligent connected vehicle j and the intelligent connected vehicle i at the time t′; r_{Agg} denotes a traffic aggressiveness-related reward function; and ƒ_{Agg}(ξ) denotes a traffic aggressiveness integral.

The driving safety-related reward function is constructed according to the following equation:

$${r}_{Safety} = {r}_{Risk} + {r}_{Agg}$$

The data-mechanism coupled planning control component is configured to: construct chassis feedback-based reinforcement learning and intelligent chassis secondary planning control architecture, and perform data-mechanism coupled planning control through real-time dynamic coupling between a vehicle chassis mechanism model and a reinforcement learning algorithm. The coupled planning control component includes three modules: a vehicle side information processing module, a reinforcement learning primary planning control module, and an intelligent chassis secondary planning control module.

The vehicle side information processing module is configured to: enable each intelligent connected vehicle to obtain semantic bird's-eye view information from the road side via V2I communication, cut a global semantic bird's-eye view based on ego-vehicle position sensor information, and combine a cut semantic bird's-eye view with sensor information and an intelligent chassis secondary planning control result, such that three state quantities are stacked across two consecutive frames as an input to the reinforcement learning primary planning control module.

The reinforcement learning primary planning control module is configured to: take a state quantity output by the vehicle side information processing module of each intelligent connected vehicle as an input to a reinforcement learning neural network, and output a corresponding primary planning control result. A primary planning control process includes steering wheel control, throttle control, and brake control:

$$steering ∈ [ - 1 , 1 ]$$

$$throttle ∈ [ 0 , 1 ]$$

$$brake ∈ [ 0 , 1 ]$$

where, steering denotes a steering wheel control quantity; throttle denotes a throttle control quantity; and brake denotes a brake control quantity. In the present disclosure, an action space∈[−1,1]² adopts two control actions: steering control and throttle-brake control. For the throttle-brake control, [−1,0] denotes brake control, and [0,1] denotes throttle control. In the present disclosure, a Beta distribution serves as an output of the reinforcement learning primary planning control module:

$$Beta = B ( α , β )$$

where, α and β denote two parameters of the Beta distribution. In the present disclosure, corresponding action control quantities are obtained by further sampling from the Beta distribution. In the present disclosure, the Beta distribution is adopted instead of the Gaussian distribution commonly used in model-free reinforcement learning due to several advantages. One advantage is that the Beta distribution dynamically simulates sample distributions of various shapes. Additionally, unlike the Gaussian distribution extending infinitely in both positive and negative directions, the Beta distribution has bounded support from 0 to 1 and requires no forced constraints. In summary, the Beta distribution provides a flexible, variable, and bounded method to simulate various sample distributions and handle bounded variables, making it a superior choice over the Gaussian distribution.

The intelligent chassis secondary planning control module is configured to: perform secondary planning control based on an intelligent chassis multi-subsystem by combining the output of the reinforcement learning primary planning control module with the desired route and yield a secondary planning control output that directly controls four-wheel torques and steering angles of the intelligent connected vehicle and provides a control quantity transmitted back to reinforcement learning primary planning control processes of each intelligent connected vehicle as part of the state quantities. A secondary planning control process constructs a coordination and cooperation problem between intelligent chassis subsystems as an optimization problem considering a global performance indicator, and is described by the following equation:

$${min}_{{U}_{i} ( t )} {J}_{i} ( {x}_{i}^{p} , {u}_{i}^{p} , {x}_{j}^{a} , {u}_{j}^{a} ) = {λ}_{i} {J}_{i} ( {x}_{i}^{p} , {u}_{i}^{p} , {x}_{j}^{a} , {u}_{j}^{a} ) + {\sum }_{j = 1 , j \neq i}^{m} {λ}_{j} {J}_{j} ( {x}_{j}^{p} , {u}_{j}^{p} , {x}_{i}^{a} , {u}_{i}^{a} ) = {λ}_{i} {‖ {X}_{i} - {W}_{i} ‖}_{{\tilde{Q}}_{i}}^{2} + {λ}_{i} {‖ {U}_{i} ‖}_{{\tilde{R}}_{i}}^{2} + {\sum }_{j = 1 , j \neq i}^{m} [ {λ}_{j} {‖ {X}_{j} - {W}_{j} ‖}_{{\tilde{Q}}_{j}}^{2} + {λ}_{j} {‖ {U}_{j} ‖}_{{\tilde{R}}_{j}}^{2} ]$$

where, Uᵢ(t) denotes a control quantity of an intelligent subsystem i at a time t; Jᵢ and Jⱼ denote total cost functions of the intelligent subsystem i and an intelligent subsystem j, respectively;

$${x}_{i}^{p}$$

denotes a predicted state of the intelligent subsystem i at a future time;

$${u}_{i}^{p}$$

denotes a control quantity of the intelligent subsystem i at the future time;

$${x}_{j}^{a}$$

denotes an assumed state of the intelligent subsystem j neighboring;

$${u}_{j}^{a}$$

denotes an assumed control quantity of the intelligent subsystem j neighboring; λᵢ denotes a coupling coefficient for cost functions between the intelligent subsystems,

$${\sum }_{i = 1}^{m} {λ}_{i} = 1 ; {X}_{i}$$

denotes a predicted state of the intelligent subsystem i; m denotes a quantity of the intelligent subsystems; Wᵢ denotes a reference state sequence of the intelligent subsystem i; Uᵢ denotes a control quantity sequence of the intelligent subsystem i; \tilde{Q}ᵢ denotes a state weight coefficient sequence; and \tilde{R}ᵢ denotes a control weight coefficient sequence of the intelligent subsystem i:

$${J}_{i} ( {x}_{i}^{p} , {u}_{i}^{p} , {x}_{j}^{a} , {u}_{j}^{a} ) = {λ}_{i} {‖ {F}_{i i} {x}_{i} ( k ) + {G}_{i i} {U}_{i} + {\sum }_{j = 1 , j \neq i}^{m} ( {F}_{i j} {X}_{j} + {G}_{i j} {U}_{j} ) - {W}_{i} ‖}_{{Q}_{i}}^{2} + {λ}_{i} {‖ {U}_{i} ‖}_{{R}_{i}}^{2} + {\sum }_{j = 1 , j \neq i}^{m} {λ}_{j} {‖ {F}_{j j} {x}_{j} ( k ) + {G}_{j j} {U}_{j} + {\sum }_{k = 1 , k \neq j}^{m} ( {F}_{j k} {X}_{k} + {G}_{j k} {U}_{k} ) - {W}_{j} ‖}_{{Q}_{j}}^{2} + {\sum }_{j = 1 , j \neq i}^{m} {λ}_{j} {‖ {U}_{j} ‖}_{{R}_{j}}^{2} = {U}_{i}^{T} {i}_{}^{} {U}_{i} + 2 ( {i}_{} + {i}_{} ) {U}_{i} + const$$

where, xᵢ(k) denotes a state of the intelligent subsystem i at a future time k; Xₖ denotes a state sequence of the intelligent subsystem at the future time k; Uₖ denotes a control quantity sequence of the intelligent subsystem j at the future time k;

$${U}_{i}^{T}$$

denotes a transpose matrix for the control quantity sequence of the intelligent subsystem i; const denotes a constant; Fᵢᵢ, Gᵢᵢ, Fᵢⱼ, Gᵢⱼ, Fⱼⱼ, Gⱼⱼ, Fⱼₖ, Gⱼₖ denote computation matrices, respectively; and Fᵢⱼ and Gᵢⱼ are constructed as follows:

$${F}_{ij} = [ \begin{matrix}{\tilde{A}}_{ij} & 0 & 0 & … & 0 \\ {\tilde{A}}_{ii} {\tilde{A}}_{ij} & {\tilde{A}}_{ij} & 0 & … & 0 \\ {\tilde{A}}_{ii}^{2} {\tilde{A}}_{ij} & {\tilde{A}}_{ii} {\tilde{A}}_{ij} & {\tilde{A}}_{ij} & … & 0 \\ ⋮ & ⋮ & ⋮ & ⋱ & ⋮ \\ {\tilde{A}}_{ii}^{{N}_{p} - 1} {\tilde{A}}_{ij} & {\tilde{A}}_{ii}^{{N}_{p} - 2} {\tilde{A}}_{ij} & {\tilde{A}}_{ii}^{{N}_{p} - 3} {\tilde{A}}_{ij} & … & {\tilde{A}}_{ij}\end{matrix} ]$$

$${G}_{ij} = [ \begin{matrix}{\tilde{B}}_{ij} & 0 & 0 & … & 0 \\ {\tilde{A}}_{ii} {\tilde{B}}_{ij} & {\tilde{B}}_{ij} & 0 & … & 0 \\ {\tilde{A}}_{ii}^{2} {\tilde{B}}_{ij} & {\tilde{A}}_{ii} {\tilde{B}}_{ij} & {\tilde{B}}_{ij} & … & 0 \\ ⋮ & ⋮ & ⋮ & ⋱ & ⋮ \\ {\tilde{A}}_{ii}^{{N}_{p} - 1} {\tilde{B}}_{ij} & {\tilde{A}}_{ii}^{{N}_{p} - 2} {\tilde{B}}_{ij} & {\tilde{A}}_{ii}^{{N}_{p} - 3} {\tilde{B}}_{ij} & … & {\tilde{B}}_{ij}\end{matrix} ]$$

where, Ãᵢᵢ denotes a state parameter of a sub-agent i; Ãᵢⱼ and \tilde{B}ᵢⱼ denote coupled state parameters of the sub-agent i and a sub-agent j, respectively; \tilde{β} denotes a coupled state parameter; Nₚ denotes a prediction time-domain; N_{c} denotes a control time-domain; other computation matrices are similar; and [symbol] , [symbol] , and [symbol] are respectively described by the following three equations:

$${i}_{} = {λ}_{i} {G}_{ii}^{T} {Q}_{i} {G}_{ii} + {λ}_{i} {R}_{i} + {\sum }_{j = 1 , j \neq i}^{m} {λ}_{j} {G}_{ji}^{T} {Q}_{i} {G}_{ji}$$

$${i}_{} = {\sum }_{j = 1}^{m} {λ}_{j} [ {x}_{j}^{T} ( k ) {F}_{jj}^{T} - {W}_{j}^{T} ] {Q}_{j} {G}_{ji}$$

$${i}_{} = {\sum }_{j = 1}^{m} {λ}_{j} [ {\sum }_{k = 1 , k \neq i}^{m} {U}_{k}^{T} {G}_{jk}^{T} + {\sum }_{k = 1 , k \neq j}^{m} {X}_{k}^{T} {F}_{jk}^{T} ] {Q}_{j} {G}_{ji}$$

where, Qᵢ denotes a state weight coefficient of the intelligent subsystem i; Rᵢ denotes a control weight coefficient of the intelligent subsystem i;

$${x}_{j}^{T} ( k )$$

denotes a transpose matrix for the state sequence of the intelligent subsystem j at the future time k;

$${W}_{j}^{T}$$

denotes a transpose matrix for a reference state sequence of the intelligent subsystem j; Qⱼ denotes a state weight coefficient of the intelligent subsystem j;

$${U}_{k}^{T}$$

denotes a transpose matrix for a control sequence of the intelligent subsystem j at the future time k;

$${X}_{k}^{T}$$

denotes a transpose matrix for the state sequence of the intelligent subsystem j at the future time k; and Gⱼᵢ denotes a computation matrix with the same structure as described above.

The data-mechanism coupled evaluation component is configured to: construct a comfort quantification index, and achieve coupled evaluation and group optimization through a neural network selection mechanism based on the vehicle chassis mechanism model. The coupled evaluation component includes three modules: a comfort index modeling module, a neural network selection module, and a neural network parameter aggregation module.

The comfort index modeling module is configured to: take three state quantities most significantly perceived by a human, including lateral acceleration, yaw angular acceleration, and longitudinal acceleration, as evaluation indexes based on a degree of state variation during vehicle driving, sequentially delineate sensitivity intervals of human perception, and take a weighted sum of squares of the three state quantities as the comfort quantification index.

$${‖ δ ‖}_{2}^{2} = {\sum }_{i = 0}^{m} {{ω}_{i} [ {S}_{i} ( t ) ]}^{2}$$

where

$${‖ δ ‖}_{2}^{2}$$

denotes an intelligent chassis-based human comfort quantification index; Sᵢ(t) denotes the lateral acceleration, the yaw angular acceleration, and the longitudinal acceleration at a time t; ωᵢ denotes a weighting parameter for the lateral acceleration, the yaw angular acceleration, and the longitudinal acceleration; and i∈[0, m], where m=3 denotes lateral, yaw angular, and longitudinal directions.

The neural network selection module is configured to: take the intelligent chassis-based human comfort quantification index as a selection criterion, and select a reinforcement learning neural network parameter corresponding to an intelligent connected vehicle with highest perceived human comfort. The selection process is described by:

$${ϕ}_{t , i}^{*} = \frac{1}{2} ( {ϕ}_{t , i} + {}_{{ϕ}_{t , {i}^{′}}}^{argmin} \vert \vert δ {\vert \vert}_{2}^{2} ) , i \neq {i}^{′}$$

where,

$${ϕ}_{t , i}^{*}$$

denotes a new network parameter aggregated from an intrinsic parameter φ_{t,i} of one intelligent connected vehicle and a parameter φ_{t,i′} of another intelligent connected vehicle at the time t.

The neural network parameter aggregation module is configured to: acquire a neural network parameter of the intelligent connected vehicle via road side V2I communication, calculate a shared neural network parameter through parameter averaging, and distribute the shared neural network parameter to the vehicle side via V2I communication for experience sharing until a network convergence is achieved. The parameter averaging is performed according to the following equation:

$${ϕ}_{m}^{*} = \frac{1}{N} {\sum }_{i} {ϕ}_{m , i}^{′}$$

where,

$${ϕ}_{m}^{*}$$

denotes the shared neural network parameter at a time m; N denotes a quantity of the intelligent connected vehicle; and

$${ϕ}_{m , i}^{′}$$

denotes the neural network parameter of the intelligent connected vehicle i at the time m.

In the present disclosure, a technical solution for constructing the vehicle-road collaborative control architecture based on data-mechanism coupled modeling includes the following steps:
step 1: performing rule-guided coupled modeling: performing information processing through a road side, utilizing a field-of-view advantage of the road side to convert an image under a bird's-eye view into a semantic bird's-eye view, modeling an interaction between intelligent connected vehicles at the road side through dynamic information in the semantic bird's-eye view, transmitting safety field information and the semantic bird's-eye view to a vehicle side via V2I communication, constructing a safety field at the vehicle side, modeling an interaction process of the intelligent connected vehicles from a road side perspective, and performing reward function modeling in two aspects: driving expectation and driving safety;
step 2: performing data-mechanism coupled planning control: constructing chassis feedback-based reinforcement learning and intelligent chassis secondary planning control architecture, and performing data-mechanism coupled planning control through real-time dynamic coupling between an intelligent chassis system and a reinforcement learning algorithm, where a coupled planning control process includes three components: vehicle side information processing, reinforcement learning primary planning control, and intelligent chassis secondary planning control; performing vehicle side information processing; acquiring, by each of the intelligent connected vehicles, semantic bird's-eye view information from the road side via the V2I communication, and cutting a global semantic bird's-eye view based on ego-vehicle position sensor information; combining a cut semantic bird's-eye view with sensor information and an intelligent chassis secondary planning control result, and stacking three state quantities across two consecutive frames as an input for the reinforcement learning primary planning control; performing the reinforcement learning primary planning control, taking state quantities output from information processing of each of the intelligent connected vehicles as an input to a reinforcement learning neural network, and generating a corresponding primary planning control result; performing the intelligent chassis secondary planning control by combining a reinforcement learning primary planning control output with a desired route based on intelligent chassis subsystems; and generating a secondary planning control output that directly controls four-wheel torques and steering angles of the intelligent connected vehicles and provides a control quantity transmitted back to reinforcement learning primary planning control processes of each of the intelligent connected vehicles as part of the state quantities;
step 3: performing data-mechanism coupled evaluation: constructing a comfort quantification index, performing coupled evaluation through a neural network selection mechanism based on a vehicle chassis mechanism model, and performing quantitative evaluation of intelligent connected vehicle control performance based on the comfort quantification index;
step 4: performing neural network selection: taking the intelligent chassis-based human comfort quantification index as a selection criterion, and selecting a reinforcement learning neural network parameter corresponding to the intelligent connected vehicles with highest perceived human comfort; and
step 5: performing neural network parameter aggregation: primarily, acquiring a neural network parameter of each of the intelligent connected vehicles via road side V2I communication, calculating a shared neural network parameter through parameter averaging, and distributing the shared neural network parameter to the vehicle side via the V2I communication for experience sharing until a network convergence is achieved.

Preferably, in the step 1, the reward function modeling considers the two aspects: the driving expectation and the driving safety:

$$r = {r}_{expectation} + {r}_{safety}$$

where, r denotes a reward function; r_{expectation} denotes a driving expectation-related reward function; and r_{safety} denotes a driving safety-related reward function.

The driving expectation-related reward function includes two aspects: lateral and longitudinal; and for a lateral driving expectation:

$$d 0 = min ( \vert \vert {a}_{28 , 28} - {b}_{desired route} {\vert \vert}^{2} ) \\ r {1}_{lateral} = - {log}_{1.1} ( \vert d 0 \vert + 1 ) \\ r {2}_{lateral} = - 10 * \vert sin ( radians ( θ ) ) \vert \\ {r}_{lateral} = r {1}_{lateral} + r {2}_{lateral}$$

where, d0 denotes a distance from a lane centerline; a_{28,28} denotes an ego-vehicle center; b_{desired route} denotes the desired route; r1ₗₐₜₑᵣₐₗ denotes a lateral distance reward function; r2ₗₐₜₑᵣₐₗ denotes a heading angle reward function; θ denotes an vehicle side heading angle deviation; and rₗₐₜₑᵣₐₗ denotes a lateral driving expectation reward function.

For a longitudinal driving expectation:

$${d}_{min} = min ( \vert \vert {a}_{28 , 28} - {b}_{x , y} {\vert \vert}^{2} ) \\ x = \{ \begin{matrix}\frac{{d}_{min}}{{v}_{ego}} , & if {d}_{min} \leq 14 \\ 1 , & if {d}_{min} > 14\end{matrix} \\ r {1}_{longitudinal} = - 5 + \sqrt{{5}^{2} ( 1 - {( x - 1 )}^{2} )} \\ r {2}_{longitudinal} = - \vert {v}_{ego} - 9 \vert \\ {r}_{longitudinal} = r {1}_{longitudinal} + r {2}_{longitudinal}$$

where, dₘᵢₙ denotes a minimum distance between autonomous vehicles; b_{x,y} denotes a surrounding-vehicle center, x denotes a collision time; v_{ego} denotes an ego-vehicle velocity; r1_{longitudinal} denotes a distance reward function; r2_{longitudinal} denotes a velocity reward function; and r_{longitudinal} denotes the longitudinal driving expectation reward function. The driving expectation-related reward function is constructed according to the following equation:

$${r}_{expectation} = {r}_{lateral} + {r}_{longitudinal}$$

The driving safety-related reward function is calculated from two aspects of a traffic safety field of the road side: traffic safety and traffic aggressiveness; and for the traffic safety:

$${R}_{i , j} ( t ) \vert {\vec{S}}_{i , j} ( t ) \vert exp ( - {k}_{c} \vert {\vec{V}}_{j} ( t ) \vert cos {θ}_{i , j} ( t ) ) \\ {r}_{Risk} = \{ \begin{matrix}{f}_{Risk} ( ξ ) = {\sum }_{j \neq i} {\sum }_{t} [ {R}_{i , j} ( t ) - {R}_{thr} ] {τ}_{rc} \\ ∀ {R}_{i , j} ( t ) ⩾ {R}_{thr}\end{matrix}$$

where, R_{i,j}(t) denotes a traffic risk; |\vec{S}_{i,j}(t)| denotes a field intensity between an intelligent connected vehicle i and an intelligent connected vehicle j; k_{c} denotes a risk perception coefficient; |\vec{V}ⱼ(t)| denotes a velocity of the intelligent connected vehicle j at a time t; θ_{i,j}(t) denotes a driving angle between the intelligent connected vehicle i and the intelligent connected vehicle j at the time t; r_{Risk} denotes a traffic risk-related reward function; ƒ_{Risk}(ξ) denotes a traffic risk integral; Rₜₕᵣ denotes a risk threshold; and τ_{rc} denotes a duration exceeding the risk threshold, and for the traffic aggressiveness:

$${R}_{i , j} ( {t}^{′} ) \vert {\vec{S}}_{j , i} ( {t}^{′} ) \vert exp ( - {k}_{c} \vert {\vec{V}}_{i} ( {t}^{′} ) \vert cos {θ}_{j , i} ( {t}^{′} ) ) \\ {r}_{Agg} = \{ \begin{matrix}{f}_{Agg} ( ξ ) = {\sum }_{j \neq i} {\sum }_{{t}^{′}} [ {R}_{i , j} ( {t}^{′} ) - {R}_{thr} ] {τ}_{rc} \\ ∀ {R}_{i , j} ( {t}^{′} ) ⩾ {R}_{thr}\end{matrix}$$

where, R_{j,i}(t′) denotes a traffic risk; |\vec{S}_{j,i}(t′)| denotes a field intensity between the intelligent connected vehicle j and the intelligent connected vehicle i; |\vec{V}ᵢ(t′)| denotes a velocity of the intelligent connected vehicle i at a time t′; θ_{j,i}(t′) denotes a driving angle between the intelligent connected vehicle j and the intelligent connected vehicle i at the time t′; r_{Agg} denotes a traffic aggressiveness-related reward function; and ƒ_{Agg}(ξ) denotes a driving traffic integral. The driving safety-related reward function is constructed according to the following equation:

$${r}_{Safety} = {r}_{Risk} + {r}_{Agg}$$

Preferably, in the step 2, the reinforcement learning primary planning control process includes steering wheel control, throttle control, and brake control:

$$\begin{matrix}steering ∈ [ - 1 , 1 ] \\ throttle ∈ [ 0 , 1 ] \\ brake ∈ [ 0 , 1 ]\end{matrix}$$

where, steering denotes a steering wheel control quantity; throttle denotes a throttle control quantity; and brake denotes a brake control quantity. In the present disclosure, an action space∈[−1,1]² adopts two control actions: steering control and throttle-brake control. For the throttle-brake control, [−1,0] denotes brake control, and [0,1] denotes throttle control. In the present disclosure, a Beta distribution serves as an output of the reinforcement learning primary planning control:

$$Beta = B ( α , β )$$

where, α and β denote two parameters of the Beta distribution. In the present disclosure, corresponding action control quantities are obtained by further sampling from the Beta distribution. In the present disclosure, the Beta distribution is adopted instead of the Gaussian distribution commonly used in model-free reinforcement learning due to several advantages. One advantage is that the Beta distribution dynamically simulates sample distributions of various shapes. Additionally, unlike the Gaussian distribution extending infinitely in both positive and negative directions, the Beta distribution has bounded support from 0 to 1 and requires no forced constraints. In summary, the Beta distribution provides a flexible, variable, and bounded method to simulate various sample distributions and handle bounded variables, making it a superior choice over the Gaussian distribution.

Preferably, in the step 2, an intelligent chassis secondary planning control process is configured to construct a coordination and cooperation problem between intelligent chassis subsystems as an optimization problem considering a global performance indicator, and is described by the following equation:

$${min}_{{U}_{i} ( t )} {J}_{i} ( {x}_{i}^{p} , {u}_{i}^{p} , {x}_{j}^{a} , {u}_{j}^{a} ) = {λ}_{i} {J}_{( i )} ( {x}_{i}^{p} , {u}_{i}^{p} , {x}_{j}^{a} , {u}_{j}^{a} ) + {\sum }_{j = 1 , j \neq i}^{m} {λ}_{j} {J}_{( j )} ( {x}_{j}^{p} , {u}_{j}^{p} , {x}_{i}^{a} , {u}_{i}^{a} ) = {λ}_{i} {‖ {X}_{i} - {W}_{i} ‖}_{{\tilde{Q}}_{i}}^{2} + {λ}_{i} {‖ {U}_{i} ‖}_{{\tilde{R}}_{i}}^{2} + {\sum }_{j = 1 , j \neq i}^{m} [ {λ}_{j} {‖ {X}_{j} - {W}_{j} ‖}_{{\tilde{Q}}_{j}}^{2} + {λ}_{j} {‖ {U}_{j} ‖}_{{\tilde{R}}_{j}}^{2} ]$$

where, Uᵢ(t) denotes a control quantity of an intelligent subsystem i at the time t; Jᵢ denotes a total cost function of the intelligent subsystem;

$${x}_{i}^{p}$$

denotes a predicted state of the intelligent subsystem i at a future time;

$${u}_{i}^{p}$$

denotes a control quantity of the intelligent subsystem i at the future time;

$${x}_{j}^{a}$$

denotes an assumed state or an intelligent subsystem j neighboring;

$${u}_{i}^{a}$$

denotes an assumed control quantity of the intelligent subsystem j neighboring; λᵢ denotes a coupling coefficient for cost functions between the intelligent subsystems,

$${\sum }_{i = 1}^{m} {λ}_{i} = 1 ;$$

Xᵢ denotes a predicted state of the intelligent subsystem i; Wᵢ denotes a reference state sequence of the intelligent subsystem i; Uᵢ denotes a control quantity sequence of the intelligent subsystem i; \tilde{Q}ᵢ denotes a state weight coefficient sequence; and \tilde{R}ᵢ denotes a control weight coefficient sequence of the intelligent subsystem i.

$${J}_{i} ( {x}_{i}^{p} , {u}_{i}^{p} , {x}_{j}^{a} , {u}_{j}^{a} ) = {λ}_{i} {‖ {F}_{ii} {x}_{i} ( k ) + {G}_{i i} {U}_{i} + {\sum }_{j = 1 , j \neq i}^{m} ( {F}_{i j} {X}_{j} + {G}_{i j} {U}_{j} ) - {W}_{i} ‖}_{{Q}_{i}}^{2} + {λ}_{i} {‖ {U}_{i} ‖}_{{R}_{i}}^{2} + {\sum }_{j = 1 , j \neq i}^{m} {λ}_{j} {‖ {F}_{j j} {x}_{j} ( k ) + {G}_{j j} {U}_{j} + {\sum }_{k = 1 , k \neq j}^{m} ( {F}_{j k} {X}_{k} + {G}_{j k} {U}_{k} ) - {W}_{j} ‖}_{{Q}_{j}}^{2} + {\sum }_{j = 1 , j \neq i}^{m} {λ}_{j} {‖ {U}_{j} ‖}_{{R}_{j}}^{2} = {U}_{i}^{T} {i}_{}^{} {U}_{i} + 2 ( {i}_{} + {i}_{} ) {U}_{i} + const$$

where, Fᵢᵢ, Gᵢᵢ, Fᵢⱼ, Gᵢⱼ, Ejj, Gⱼⱼ, Fⱼₖ, and Gⱼₖ denote computation matrices, respectively; xᵢ(k) denotes a state of the intelligent subsystem i at a future time k; Xₖ denotes a state sequence of the intelligent subsystem at the future time k; Uₖ denotes a control quantity sequence of the intelligent subsystem j at the future time k;

$${U}_{i}^{T}$$

denotes a transpose matrix for the control quantity sequence of the intelligent subsystem i; and const denotes a constant; [symbol] , [symbol] , and [symbol] are respectively described by the following three equations:

$$\begin{matrix}{i}_{}^{} = {λ}_{i} {G}_{i i}^{T} {Q}_{i} {G}_{i i} + {λ}_{i} {R}_{i} + {\sum }_{j = 1 , j \neq i}^{m} {λ}_{j} {G}_{j i}^{T} {Q}_{i} {G}_{j i} \\ {i}_{} = {\sum }_{j = 1}^{m} {λ}_{j} [ {x}_{j}^{T} ( k ) {F}_{j j}^{T} - {W}_{j}^{T} ] {Q}_{j} {G}_{j i} \\ {i}_{} = {\sum }_{j = 1}^{m} {λ}_{j} [ {\sum }_{k = 1 , k \neq i}^{m} {U}_{k}^{T} {G}_{j k}^{T} + {\sum }_{k = 1 , k \neq j}^{m} {X}_{k}^{T} {F}_{j k}^{T} ] {Q}_{j} {G}_{j i}\end{matrix}$$

where, Qᵢ denotes a state weight coefficient of the intelligent subsystem i; Rᵢ denotes a control weight coefficient of the intelligent subsystem i;

$${x}_{j}^{T} ( k )$$

denotes a transpose matrix for the state sequence of the intelligent subsystem j at the future time k;

$${W}_{j}^{T}$$

denotes a transpose matrix for a reference state sequence of the intelligent subsystem j; Qⱼ denotes a state weight coefficient of the intelligent subsystem j;

$${U}_{k}^{T}$$

denotes a transpose matrix for a control sequence of the intelligent subsystem j at the future time k; and

$${X}_{k}^{T}$$

denotes a transpose matrix for the state sequence of the intelligent subsystem j at the future time k.

Preferably, in the step 3, the comfort index modeling is configured to: take three state quantities most significantly perceived by a human, including lateral acceleration, yaw angular acceleration, and longitudinal acceleration, as evaluation indexes based on a degree of state variation during vehicle driving, sequentially delineate sensitivity intervals of human perception, and take a weighted sum of squares of the three state quantities as the comfort quantification index:

$${‖ δ ‖}_{2}^{2} = {\sum }_{i = 0}^{m} {ω}_{i} {{S}_{i} ( t )}^{2}$$

where,

$${‖ δ ‖}_{2}^{2}$$

denotes an intelligent chassis-based human comfort quantification index; Sᵢ(t) denotes the lateral acceleration, the yaw angular acceleration, and the longitudinal acceleration at a time t; ωᵢ denotes a weighting parameter for the lateral acceleration, the yaw angular acceleration, and the longitudinal acceleration; and i∈[0, m], where m=3 denotes lateral, yaw angular, and longitudinal directions.

Preferably, in the step 4, the selection process is described by:

$${ϕ}_{t , i}^{*} = \frac{1}{2} ( {ϕ}_{t , i} + {arg min}_{{ϕ}_{t , {i}^{′}}} {‖ δ ‖}_{2}^{2} ) , i \neq {i}^{′}$$

where,

$${ϕ}_{t , i}^{*}$$

denotes a new network parameter aggregated from an intrinsic parameter φ_{t,i} of one of the intelligent connected vehicles and a parameter φ_{t,i′} of another of the intelligent connected vehicles at the time t.

Preferably, in the step 5, the parameter averaging is performed according to the following equation:

$${ϕ}_{m}^{*} = \frac{1}{N} {\sum }_{i} {ϕ}_{m , i}^{′}$$

where,

$${ϕ}_{m}^{*}$$

denotes the shared neural network parameter at a time m; N denotes a quantity of the intelligent connected vehicles; and

$${ϕ}_{m , i}^{′}$$

denotes the neural network parameter of the intelligent connected vehicle i at the time m.

The present disclosure has the following advantages:
(1) The present disclosure proposes a data-mechanism fusion-driven multi-agent system modeling method, a vehicle-road collaborative group optimization method based on federated reinforcement learning, and constructs a vehicle decision-making model parameter update technology based on multi-dimensional experience sharing. The present disclosure solves the explainability and generalization problems of purely data-driven models.
(2) The present disclosure utilizes road side advantages to build a rule-based traffic safety field and achieves rule-guided data-driven training. The present disclosure proposes a data-mechanism coupled driving model to address the difficulty of traditional mechanism modeling in autonomous driving, constructs an intelligent chassis-based secondary planning control framework, and innovatively proposes a chassis feedback-based state quantity input. Thus, the present disclosure solves problems of purely data-driven methods, including questionable trustworthiness, reliance on large-scale data, and opaque and unexplainable decision-making processes. The present disclosure constructs a comfort quantification index for selecting locally optimal strategies for current environments by introducing weighted lateral acceleration, yaw angular acceleration, and longitudinal acceleration based on human perception sensitivity intervals. The present disclosure achieves a balance between sample efficiency and model robustness by synthesizing globally shared models benefiting from different environments.

### BRIEF DESCRIPTION OF THE DRAWINGS

FIG. 1 is a schematic diagram of rule-guided coupled modeling according to the present disclosure;

FIG. 2 is a schematic diagram of data-mechanism coupled planning control according to the present disclosure; and

FIG. 3 is a schematic diagram of data-mechanism coupled evaluation according to the present disclosure.

### DETAILED DESCRIPTION OF THE EMBODIMENTS

The technical solutions of the present disclosure are described in detail below with reference to the drawings, but the present disclosure is not limited thereto.

The present disclosure provides vehicle-road collaborative control architecture based on data-mechanism coupled modeling, specifically including the following steps.

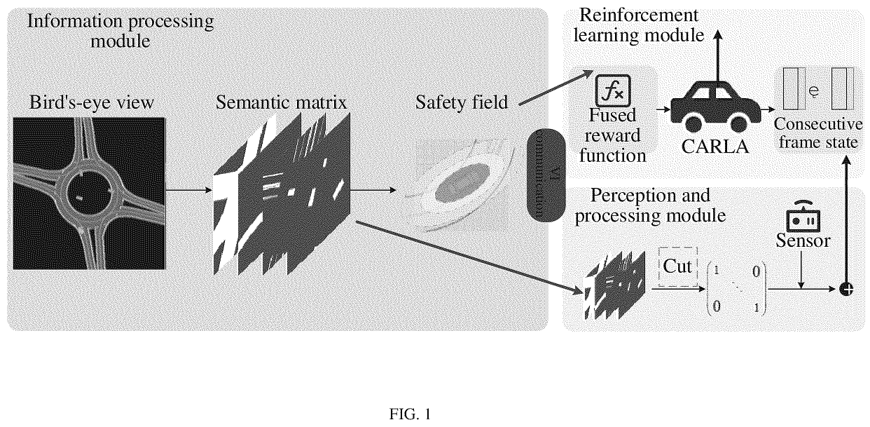

(1) Rule-guided coupled modeling is performed, as shown in FIG. 1. Information processing is performed through a road side, a field-of-view advantage of the road side is utilized to convert an image under a bird's-eye view into a semantic bird's-eye view, an interaction between intelligent connected vehicles is modeled at the road side through dynamic information in the semantic bird's-eye view, safety field information and the semantic bird's-eye view are transmitted to a vehicle side via V2I communication. A safety field is constructed at the vehicle side to model an interaction process of the intelligent connected vehicles from a road side perspective. The safety field is constructed according to following equations:

$${S}_{sta} = {C}_{a} \cdot exp ( - \frac{{( x - {x}_{0} )}^{2}}{{a}_{x}^{2}} - \frac{{( y - {y}_{0} )}^{2}}{{b}_{y}^{2}} )$$

$$ε = \frac{{a}_{x}^{2} - {b}_{y}^{2}}{{a}_{x}^{2} + {b}_{y}^{2}} = \frac{{ϕ}^{2} - 1}{{ϕ}^{2} + 1}$$

$$ϕ = {a}_{x} / {b}_{y} = {l}_{v} / {w}_{v}$$

where, Sₛₜₐ denotes a static safety field intensity; Cₐ denotes a static safety field intensity coefficient; x₀ and y₀ denote coordinates of a static risk center O(x₀, y₀); aₓ and b_{y} denote appearance coefficients of the intelligent connected vehicles; φ denotes a length-width ratio of the intelligent connected vehicles; lᵥ denotes a vehicle length; and wᵥ denotes a vehicle width.

When the intelligent connected vehicle moves, the risk center O(x₀, y₀) of a Gaussian safety field shifts with vehicle movement to form a new risk center

$${O}^{′} ( {x}_{0}^{′} , {y}_{0}^{′} ) \text{:} \{ \begin{matrix}{x}_{0}^{′} = {x}_{0} + {k}_{v} \vert \vec{v} \vert cos β \\ {y}_{0}^{′} = {y}_{0} + {k}_{v} \vert \vec{v} \vert sin β\end{matrix}$$

$${S}_{dyn} = {C}_{a} \cdot exp ( - \frac{{( x - {x}_{0}^{′} )}^{2}}{{( {a}_{x}^{′} )}^{2}} - \frac{{( y - {y}_{0}^{′} )}^{2}}{{( {b}_{y}^{′} )}^{2}} )$$

where, kᵥ denotes a movement adjustment factor, kᵥ [symbol] {(−1,0)∪(0,1)}, with a sign correlated with a movement direction; and β denotes an angle between a shift vector kᵥ|\vec{v}| of the intelligent connected vehicle and a coordinate axis in a Cartesian system. A virtual vehicle with a length of

$${l}_{v}^{l}$$

and a width of

$${w}_{v}^{′}$$

is formed in a dynamic safety field under shifting of the risk center; S_{dyn} denotes a dynamic safety field intensity, and a new length-width ratio is denoted as

$${ϕ}^{′} = {a}_{x}^{′} / {b}_{y}^{′} = {l}_{v}^{′} / {w}_{v}^{′} .$$

Reward function modeling is performed in two aspects: driving expectation and driving safety:

$$r = {r}_{expectation} + {r}_{safety}$$

where, r denotes the reward function; r_{expectation} denotes a driving expectation-related reward function; and r_{safety} denotes a driving safety-related reward function. The driving expectation-related reward function includes two aspects: lateral and longitudinal; and for a lateral driving expectation:

$$d 0 = min ( {‖ {a}_{28 , 28} - {b}_{desired route} ‖}^{2} )$$

$$r {1}_{lateral} = - {log}_{1.1} ( \vert d 0 \vert + 1 )$$

$$r {2}_{lateral} = - 10 * \vert sin ( radians ( θ ) ) \vert$$

$${r}_{lateral} = r {1}_{lateral} + r {2}_{lateral}$$

where, d0 denotes a distance from a lane centerline; a_{28,28} denotes an ego-vehicle center; b_{desired route} denotes a desired route; r1ₗₐₜₑᵣₐₗ denotes a lateral distance reward function; r2ₗₐₜₑᵣₐₗ denotes a heading angle reward function; θ denotes an vehicle side heading angle deviation; and rₗₐₜₑᵣₐₗ denotes a lateral driving expectation reward function.

For a longitudinal driving expectation:

$${d}_{min} = min ( {‖ {a}_{28 , 28} - {b}_{x , y} ‖}^{2} )$$

$$x = \{ \begin{matrix}\frac{{d}_{min}}{{v}_{ego}} , & if {d}_{min} \leq 14 \\ 1 , & if {d}_{min} > 14\end{matrix}$$

$$r {1}_{longitudinal} = - 5 + \sqrt{{5}^{2} ( 1 - {( x - 1 )}^{2} )}$$

$$r {2}_{longitudinal} = - \vert {v}_{ego} - 9 \vert$$

$${r}_{longitudinal} = r {1}_{longitudinal} + r {2}_{longitudinal}$$

where, dₘᵢₙ denotes a minimum distance between autonomous vehicles; b_{x,y} denotes a surrounding-vehicle center, x denotes a collision time; v_{ego} denotes an ego-vehicle velocity; r1_{longitudinal} denotes a distance reward function; r2_{longitudinal} denotes a velocity reward function; and r_{longitudinal} denotes a longitudinal driving expectation reward function. The driving expectation-related reward function is constructed according to the following equation:

$${r}_{expectation} = {r}_{lateral} + {r}_{longitudinal}$$

The driving safety-related reward function is calculated from two aspects of the traffic safety field of the road side: traffic safety and traffic aggressiveness; and for the traffic safety:

$${R}_{i , j} ( t ) = \vert {\vec{S}}_{i , j} ( t ) \vert exp ( - {k}_{c} \vert {\vec{V}}_{j} ( t ) \vert cos {θ}_{i , j} ( t ) )$$

$${r}_{Risk} = \{ \begin{matrix}{f}_{Risk} ( ξ ) = {\sum }_{j \neq i} {\sum }_{t} [ {R}_{i , j} ( t ) - {R}_{thr} ] {τ}_{rc} \\ ∀ {R}_{i , j} ( t ) ⩾ {R}_{thr}\end{matrix}$$

where, R_{i,j}(t) denotes a traffic risk caused by an intelligent connected vehicle j toward an intelligent connected vehicle i; |\vec{S}_{i,j}(t)| denotes a field intensity of the intelligent connected vehicle j toward the intelligent connected vehicle i; k_{c} denotes a risk perception coefficient; |\vec{V}ⱼ(t)| denotes a velocity of the intelligent connected vehicle j at a time t; θ_{i,j}(t) denotes a driving angle between the intelligent connected vehicle i and the intelligent connected vehicle j at the time t; r_{Risk} denotes a traffic risk-related reward function; ƒ_{Risk}(ξ) denotes a traffic risk integral; Rₜₕᵣ denotes a risk threshold; and τ_{rc} denotes a duration exceeding the risk threshold, and for the traffic aggressiveness:

$${R}_{j , i} ( {t}^{′} ) = \vert {\vec{S}}_{j , i} ( {t}^{′} ) \vert exp ( - {k}_{c} \vert {\vec{V}}_{i} ( {t}^{′} ) \vert cos {θ}_{j , i} ( {t}^{′} ) )$$

$${r}_{Agg} = \{ \begin{matrix}{f}_{Agg} ( ξ ) = {\sum }_{j \neq i} {\sum }_{{t}^{′}} [ {R}_{j , i} ( {t}^{′} ) - {R}_{thr} ] {τ}_{rc} \\ ∀ {R}_{j , i} ( {t}^{′} ) ⩾ {R}_{thr}\end{matrix}$$

where, R_{j,i}(t′) denotes a traffic risk caused by the intelligent connected vehicle i toward the intelligent connected vehicle j; |S_{j,i}(t′)| denotes a field intensity of the intelligent connected vehicle i toward the intelligent connected vehicle j; |\vec{V}ᵢ(t′)| denotes a velocity of the intelligent connected vehicle i at a time t′; θ_{j,i}(t′) denotes a driving angle between the intelligent connected vehicle j and the intelligent connected vehicle i at the time t′; r_{Agg} denotes a traffic aggressiveness-related reward function; and ƒ_{Agg}(ξ) denotes a traffic aggressiveness integral. The driving safety-related reward function is constructed according to the following equation:

$${r}_{Safety} = {r}_{Risk} + {r}_{Agg}$$

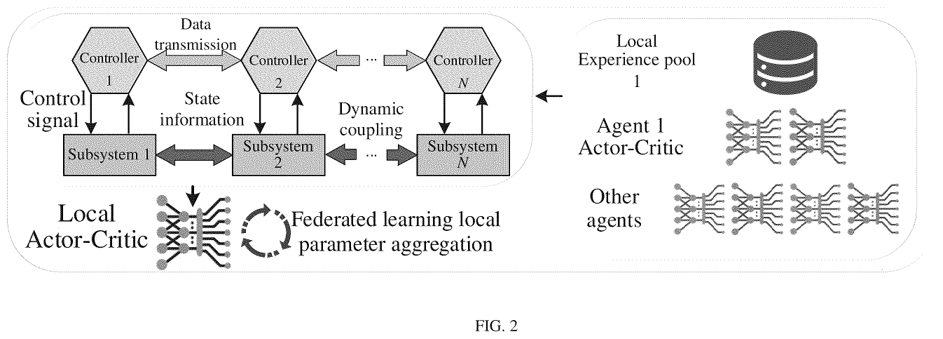

(2) Data-mechanism coupled planning control is performed, as shown in FIG. 2. Chassis feedback-based reinforcement learning and intelligent chassis secondary planning control architecture is constructed, and data-mechanism coupled planning control is achieved through real-time dynamic coupling between a vehicle chassis mechanism model and a reinforcement learning algorithm. A coupled planning control process includes three components: vehicle side information processing, reinforcement learning primary planning control, and intelligent chassis secondary planning control. Vehicle side information processing is performed, semantic bird's-eye view information from the road side is acquired by each intelligent connected vehicle via V2I communication, and a global semantic bird's-eye view is cut based on ego-vehicle position sensor information. The cut semantic bird's-eye view is combined with sensor information and an intelligent chassis secondary planning control result, and the three state quantities are stacked across two consecutive frames as an input for the reinforcement learning primary planning control. The reinforcement learning primary planning control is performed, state quantities output from information processing of each intelligent connected vehicle are taken as an input to a reinforcement learning neural network, and a corresponding primary planning control result is generated. A primary planning control process includes steering wheel control, throttle control, and brake control:

$$steering ∈ [ - 1 , 1 ]$$

$$throttle ∈ [ 0 , 1 ]$$

$$brake ∈ [ 0 , 1 ]$$

where, steering denotes a steering wheel control quantity; throttle denotes a throttle control quantity; and brake denotes a brake control quantity. In the present disclosure, an action space∈[−1,1]² adopts two control actions: steering control and throttle-brake control. For the throttle-brake control, [−1,0] denotes brake control, and [0,1] denotes throttle control. In the present disclosure, a Beta distribution serves as an output of the reinforcement learning primary planning control:

$$Beta = B ( α , β )$$

where, α and β denote two parameters of the Beta distribution. In the present disclosure, corresponding action control quantities are obtained by further sampling from the Beta distribution. In the present disclosure, the Beta distribution is adopted instead of the Gaussian distribution commonly used in model-free reinforcement learning due to several advantages. One advantage is that it dynamically simulates sample distributions of various shapes. Additionally, unlike the Gaussian distribution extending infinitely in both positive and negative directions, the Beta distribution has bounded support from 0 to 1 and requires no forced constraints. In summary, the Beta distribution provides a flexible, variable, and bounded method to simulate various sample distributions and handle bounded variables, making it a superior choice over the Gaussian distribution.

Intelligent chassis secondary planning control is performed. Secondary planning control is performed based on intelligent chassis subsystems performed by combining a reinforcement learning primary planning control output with a desired route. A secondary planning control output is generated, which directly controls four-wheel torques and steering angles of the intelligent connected vehicle and provides a control quantity transmitted back to reinforcement learning primary planning control processes of each intelligent connected vehicle as part of the state quantities. A secondary planning control process constructs a coordination and cooperation problem between intelligent chassis subsystems as an optimization problem considering a global performance indicator, and is described by the following equation:

$${min}_{{U}_{i} ( t )} {J}_{i} ( {x}_{i}^{p} , {u}_{i}^{p} , {x}_{j}^{a} , {u}_{j}^{a} ) = {λ}_{i} {J}_{( i )} ( {x}_{i}^{p} , {u}_{i}^{p} , {x}_{j}^{a} , {u}_{j}^{a} ) + {\sum }_{j = 1 , j \neq i}^{m} {λ}_{j} {J}_{( j )} ( {x}_{j}^{p} , {u}_{j}^{p} , {x}_{i}^{a} , {u}_{i}^{a} ) = {λ}_{i} {‖ {X}_{i} - {W}_{i} ‖}_{{\tilde{Q}}_{i}}^{2} + {λ}_{i} {‖ {U}_{i} ‖}_{{\tilde{R}}_{i}}^{2} + {\sum }_{j = 1 , j \neq i}^{m} [ {λ}_{j} {‖ {X}_{j} - {W}_{j} ‖}_{{\tilde{Q}}_{j}}^{2} + {λ}_{j} {‖ {U}_{j} ‖}_{{\tilde{R}}_{j}}^{2} ]$$

where, Uᵢ(t) denotes a control quantity of an intelligent subsystem i at a time t; Jᵢ denotes a total cost function of the intelligent subsystem;

$${x}_{i}^{p}$$

denotes a predicted state of the intelligent subsystem i at a future time;

$${u}_{i}^{p}$$

denotes a control quantity of the intelligent subsystem i at the future time,

$${x}_{j}^{a}$$

denotes an assumed state of the intelligent subsystem j neighboring;

$${u}_{i}^{a}$$

denotes an assumed control quantity of the intelligent subsystem j neighboring; λᵢ denotes a coupling coefficient for cost functions between the intelligent subsystems,

$${\sum }_{i = 1}^{m} {λ}_{i} = 1 ;$$

Xᵢ denotes a predicted state of the intelligent subsystem i; Wᵢ denotes a reference state sequence of the intelligent subsystem i; Uᵢ denotes a control quantity sequence of the intelligent subsystem i; \tilde{Q}ᵢ denotes a state weight coefficient sequence; and \tilde{R}ᵢ denotes a control weight coefficient sequence of the intelligent subsystem i.

$${J}_{i} ( {x}_{i}^{p} , {u}_{i}^{p} , {x}_{j}^{a} , {u}_{j}^{a} ) = {λ}_{i} {‖ {F}_{ii} {x}_{i} ( k ) + {G}_{ii} {U}_{i} + {\sum }_{j = 1 , j \neq i}^{m} ( {F}_{ij} {X}_{j} + {G}_{ij} {U}_{j} ) - {W}_{i} ‖}_{{Q}_{i}}^{2} + {λ}_{i} {‖ {U}_{i} ‖}_{{R}_{i}}^{2} + {\sum }_{j = 1 , j \neq i}^{m} {λ}_{j} {‖ {F}_{jj} {x}_{j} ( k ) + {G}_{jj} {U}_{j} + {\sum }_{k = 1 , k \neq j}^{m} ( {F}_{jk} {X}_{k} + {G}_{jk} {U}_{k} ) - {W}_{j} ‖}_{{Q}_{j}}^{2} + {\sum }_{j = 1 , j \neq i}^{m} {λ}_{j} {‖ {U}_{j} ‖}_{{R}_{j}}^{2} = {U}_{i}^{T} {i}_{} {U}_{i} + 2 ( {i}_{} + {i}_{} ) {U}_{i} + const$$

where, Fᵢᵢ, Gᵢᵢ, Fᵢⱼ, Gᵢⱼ, Fⱼⱼ, Gⱼⱼ, Fⱼₖ, and Gⱼₖ denote computation matrices, respectively; xᵢ(k) denotes a state of the intelligent subsystem i at a future time k; Xₖ denotes a state sequence of the intelligent subsystem at the future time k; Uₖ denotes a control quantity sequence of the intelligent subsystem j at the future time k;

$${U}_{i}^{T}$$

denotes a transpose matrix for the control quantity sequence of the intelligent subsystem i; and const denotes a constant; [symbol] , [symbol] , and [symbol] are respectively described by the following three equations:

$$\begin{matrix}{i}_{}^{} = {λ}_{i} {G}_{i i}^{T} {Q}_{i} {G}_{i i} + {λ}_{i} {R}_{i} + {\sum }_{j = 1 , j \neq i}^{m} {λ}_{j} {G}_{j i}^{T} {Q}_{i} {G}_{j i} \\ {i}_{} = {\sum }_{j = 1}^{m} {λ}_{j} [ {x}_{j}^{T} ( k ) {F}_{j j}^{T} - {W}_{j}^{T} ] {Q}_{j} {G}_{j i} \\ {i}_{} = {\sum }_{j = 1}^{m} {λ}_{j} [ {\sum }_{k = 1 , k \neq i}^{m} {U}_{k}^{T} {G}_{j k}^{T} + {\sum }_{k = 1 , k \neq j}^{m} {X}_{k}^{T} {F}_{j k}^{T} ] {Q}_{j} {G}_{j i}\end{matrix}$$

where, Qᵢ denotes a state weight coefficient of the intelligent subsystem i; Rᵢ denotes a control weight coefficient of the intelligent subsystem i;

$${x}_{j}^{T} ( k )$$

denotes a transpose matrix for the state sequence of the intelligent subsystem j at the future time k;

$${W}_{j}^{T}$$

denotes a transpose matrix for a reference state sequence of the intelligent subsystem j; Qⱼ denotes a state weight coefficient of the intelligent subsystem j;

$${U}_{k}^{T}$$

denotes a transpose matrix for a control sequence of the intelligent subsystem j at the future time k; and

$${X}_{k}^{T}$$

denotes a transpose matrix for the state sequence of the intelligent subsystem j at the future time k.

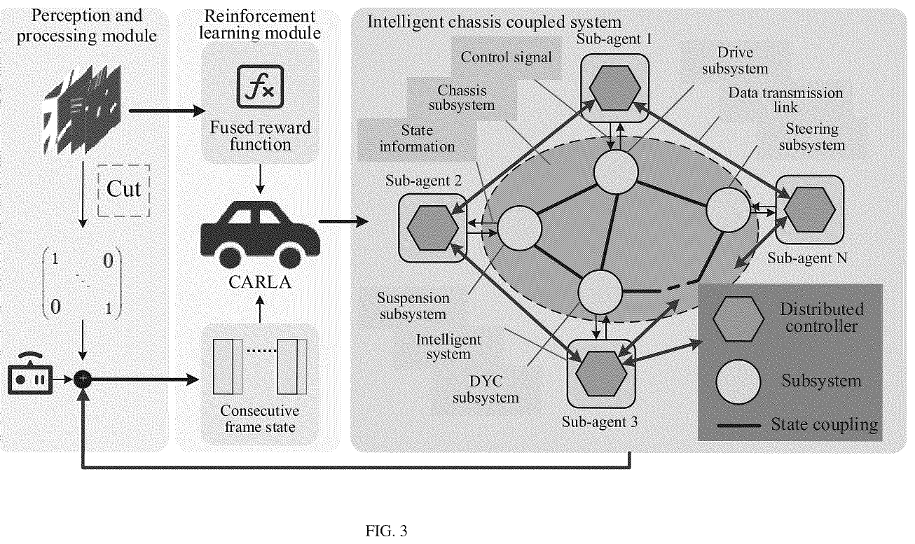

(3) Data-mechanism coupled evaluation is performed, as shown in FIG. 3. A comfort quantification index is constructed, coupled evaluation is performed through a neural network selection mechanism based on a vehicle chassis mechanism model, and quantitative evaluation of intelligent connected vehicle control performance is performed based on the comfort quantification index. The comfort index modeling is configured to: take three state quantities most significantly perceived by a human, including lateral acceleration, yaw angular acceleration, and longitudinal acceleration, as evaluation indexes based on a degree of state variation during vehicle driving, sequentially delineate sensitivity intervals of human perception, and take a weighted sum of squares of the three state quantities as the quantification index:

$${‖ δ ‖}_{2}^{2} = {\sum }_{i = 0}^{m} {ω}_{i} {{S}_{i} ( t )}^{2}$$

where,

$${‖ δ ‖}_{2}^{2}$$

denotes an intelligent chassis-based human comfort quantification index; Sᵢ(t) denotes the lateral acceleration, the yaw angular acceleration, and the longitudinal acceleration at a time t; ωᵢ denotes a weighting parameter for the lateral acceleration, the yaw angular acceleration, and the longitudinal acceleration; and i∈[0, m], where m=3 denotes lateral, yaw angular, and longitudinal directions.

(4) Neural network selection is performed. The intelligent chassis-based human comfort quantification index is taken as a selection criterion, and a reinforcement learning neural network parameter corresponding to an intelligent connected vehicle with highest perceived human comfort is selected. A selection process is described by:

$${ϕ}_{t , i}^{*} = \frac{1}{2} ( {ϕ}_{t , i} + {}_{{ϕ}_{t , {i}^{′}}}^{argmin} {‖ δ ‖}_{2}^{2} ) , \qquad i \neq {i}^{′}$$

where,

$${ϕ}_{t , i}^{*}$$

denotes a new network parameter aggregated from an intrinsic parameter φ_{t,i} of one intelligent connected vehicle and a parameter φ_{t,i′} of another intelligent connected vehicle at the time t.

(5) Neural network parameter aggregation is performed. Primarily, neural network parameters of the intelligent connected vehicles are acquired via road side V2I communication, a shared neural network parameter is calculated through parameter averaging and distributed to the vehicle side via V2I communication for experience sharing until a network convergence is achieved. The parameter averaging is performed according to the following equation:

$${ϕ}_{m}^{*} = \frac{1}{N} {\sum }_{i} {ϕ}_{m , i}^{′}$$

where,

$${ϕ}_{m}^{*}$$

denotes the shared neural network parameter at a time m; N denotes a quantity of the intelligent connected vehicles; and

$${ϕ}_{m , i}^{′}$$

denotes the neural network parameter of the intelligent connected vehicle i at the time m.

Overall, the present disclosure provides a vehicle-road collaborative control architecture based on data-mechanism coupled modeling. The present disclosure proposes a data-mechanism fusion-driven multi-agent system modeling method, a vehicle-road collaborative group optimization method based on federated reinforcement learning, and constructs a vehicle decision-making model parameter update technology based on multi-dimensional experience sharing. The present disclosure solves the explainability and generalization problems of purely data-driven models. The present disclosure solves the explainability and generalization problems of purely data-driven models. The present disclosure utilizes road side advantages to build a rule-based traffic safety field and achieves rule-guided data-driven training. The present disclosure proposes a data-mechanism coupled driving model to address the difficulty of traditional mechanism modeling in autonomous driving, constructs an intelligent chassis-based secondary planning control framework, and innovatively proposes a chassis feedback-based state quantity input. Thus, the present disclosure solves problems of purely data-driven methods, including questionable trustworthiness, reliance on large-scale data, and opaque and unexplainable decision-making processes. The present disclosure constructs a comfort quantification index for selecting locally optimal strategies for current environments by introducing weighted lateral acceleration, yaw angular acceleration, and longitudinal acceleration based on human perception sensitivity intervals. The present disclosure achieves a balance between sample efficiency and model robustness by synthesizing globally shared models benefiting from different environments.

The series of detailed descriptions listed above are only specific illustration of feasible implementations of the present disclosure, rather than limiting the claimed scope of the present disclosure. All equivalent manners or changes made without departing from the technical spirit of the present disclosure should be included in the claimed scope of the present disclosure.

1. A vehicle-road collaborative control architecture system based on data-mechanism coupled modeling, comprising: a rule-guided coupled modeling component, a data-mechanism coupled planning control component, and a data-mechanism coupled evaluation component, wherein
the rule-guided coupled modeling component is configured to: process bird's-eye view information by a road side to construct a traffic safety field, and provide guidance for a data-driven control training process by constructing a fused reward function;
the data-mechanism coupled planning control component is configured to: construct chassis feedback-based reinforcement learning and intelligent chassis secondary planning control algorithm, and perform data-mechanism coupled planning control through real-time dynamic coupling between a vehicle chassis mechanism model and a reinforcement learning algorithm; and
the data-mechanism coupled evaluation component is configured to: construct a comfort quantification index, and achieve coupled evaluation and group optimization through neural network selection based on the vehicle chassis mechanism model.

2. The vehicle-road collaborative control architecture system based on the data-mechanism coupled modeling according to claim 1, wherein the rule-guided coupled modeling component comprises: a road side information processing module, a safety field modeling module, and a reward function modeling module;
wherein, the road side information processing module is configured to: utilize a field-of-view advantage of the road side to convert an image under a bird's-eye view into a semantic bird's-eye view, model an interaction between intelligent connected vehicles at the road side through dynamic information in the semantic bird's-eye view, and transmit safety field information and the semantic bird's-eye view to a vehicle side via vehicle-to-infrastructure (V2I) communication;
the safety field modeling module is configured to: construct a safety field according to following equations:
$$\begin{matrix}{S}_{sta} = {C}_{a} \cdot exp ( - \frac{{( x - {x}_{0} )}^{2}}{{a}_{x}^{2}} - \frac{{( y - {y}_{0} )}^{2}}{{b}_{y}^{2}} ) \\ ε = \frac{{a}_{x}^{2} - {b}_{y}^{2}}{{a}_{x}^{2} + {b}_{y}^{2}} = \frac{{ϕ}^{2} - 1}{{ϕ}^{2} + 1} \\ ϕ = {a}_{x} / {b}_{y} = {l}_{v} / {w}_{v}\end{matrix}$$
wherein, Sₛₜₐ denotes a static safety field intensity; Cₐ denotes a static safety field intensity coefficient; x₀ and y₀ denote coordinates of a static risk center O(x₀, y₀); ε denotes a safety field shape coefficient; aₓ and b_{y} denote appearance coefficients of the intelligent connected vehicles; φ denotes a length-width ratio of the intelligent connected vehicles; lᵥ denotes a vehicle length; and wᵥ denotes a vehicle width; and
the reward function modeling module considers two aspects: driving expectation and driving safety:
$$r = {r}_{expectation} + {r}_{safety}$$
wherein, r denotes a reward function; r_{expectation} denotes a driving expectation-related reward function; and r_{safety} denotes a driving safety-related reward function.

3. The vehicle-road collaborative control architecture system based on the data-mechanism coupled modeling according to claim 2, wherein the semantic bird's-eye view is a 4-channel matrix, comprising static road information and lane line information, along with dynamic desired route information and vehicle information.

4. The vehicle-road collaborative control architecture system based on the data-mechanism coupled modeling according to claim 2, wherein when the intelligent connected vehicles move, a risk center O(x₀, y₀) of a Gaussian safety field shifts with vehicle movement to form a new risk center
$$\begin{matrix}{O}^{′} ( {x}_{0}^{′} , {y}_{0}^{′} ) : \{ \begin{matrix}{x}_{0}^{′} = {x}_{0} + {k}_{v} \vert \vec{v} \vert cos β \\ {y}_{0}^{′} = {y}_{0} + {k}_{v} \vert \vec{v} \vert sin β\end{matrix} \\ {S}_{d y n} = {C}_{a} \cdot exp ( - \frac{{( x - {x}_{0}^{′} )}^{2}}{{( {a}_{x}^{′} )}^{2}} - \frac{{( y - {y}_{0}^{′} )}^{2}}{{( {b}_{y}^{′} )}^{2}} )\end{matrix}$$
wherein, kᵥ denotes a movement adjustment factor, kᵥ [symbol] {(−1,0)∪(0,1)}, with a sign correlated with a movement direction; β denotes an angle between a shift vector kᵥ|\vec{v}| of the intelligent connected vehicles and a coordinate axis in a Cartesian system; a virtual vehicle with a length of
$${{l}_{v}}^{′}$$
and a width of
$${w}_{v}^{′}$$
is formed in a dynamic safety field under shifting of the risk center; S_{dyn} denotes a dynamic safety field intensity; and a new length-width ratio is denoted as
$${ϕ}^{′} = {a}_{x}^{′} / {b}_{y}^{′} = {l}_{v}^{′} / {w}_{v}^{′} .$$

5. The vehicle-road collaborative control architecture system based on the data-mechanism coupled modeling according to claim 2, wherein the driving expectation-related reward function comprises two aspects: lateral and longitudinal;
for a lateral driving expectation reward function:
$$d 0 = min ( {‖ {a}_{28 , 28} - {b}_{desired route} ‖}^{2} )$$
$$r {1}_{lateral} = - {log}_{1.1} ( \vert d 0 \vert + 1 )$$
$$r {2}_{lateral} = - 10 * \vert sin ( radians ( θ ) ) \vert$$
$${r}_{lateral} = r {1}_{lateral} + r {2}_{lateral}$$
wherein, d0 denotes a distance from a lane centerline; a_{28,28} denotes an ego-vehicle center; b_{desired route} denotes a desired route; r1ₗₐₜₑᵣₐₗ denotes a lateral distance reward function; r2ₗₐₜₑᵣₐₗ denotes a heading angle reward function; θ denotes an vehicle side heading angle deviation; and rₗₐₜₑᵣₐₗ denotes the lateral driving expectation reward function;
for a longitudinal driving expectation reward function:
$${d}_{min} = min ( {‖ {a}_{28 , 28} - {b}_{x , y} ‖}^{2} )$$
$$x = \{ \begin{matrix}\frac{{d}_{min}}{{v}_{ego}} , & if {d}_{min} \leq 14 \\ 1 , & if {d}_{min} > 14\end{matrix}$$
wherein, dₘᵢₙ denotes a minimum distance between autonomous vehicles; b_{x,y} denotes a surrounding-vehicle center, x denotes a collision time; v_{ego} denotes an ego-vehicle velocity; r1_{longitudinal} denotes a distance reward function; r2_{longitudinal} denotes a velocity reward function; and r_{longitudinal} denotes the longitudinal driving expectation reward function; and
the driving expectation-related reward function is constructed according to the following equation:
$${r}_{expectation} = {r}_{lateral} + {r}_{longitudinal} .$$

6. The vehicle-road collaborative control architecture system based on the data-mechanism coupled modeling according to claim 2, wherein the driving safety-related reward function is calculated from two aspects of the traffic safety field of the road side: traffic safety and traffic aggressiveness; and for the traffic safety:
$${R}_{i , j} ( t ) = \vert {\vec{S}}_{i , j} ( t ) \vert exp ( - {k}_{c} \vert {\vec{V}}_{j} ( t ) \vert cos {θ}_{i , j} ( t ) )$$
$${r}_{Risk} = \{ \begin{matrix}{f}_{Risk} ( ξ ) = {\sum }_{j \neq i} {\sum }_{t} [ {R}_{i , j} ( t ) - {R}_{thr} ] {τ}_{rc} \\ ∀ {R}_{i , j} ( t ) ⩾ {R}_{thr}\end{matrix}$$
wherein, R_{i,j}(t) denotes a traffic risk caused by an intelligent connected vehicle j toward an intelligent connected vehicle i; |\vec{S}_{i,j}(t)| denotes a field intensity of the intelligent connected vehicle j toward the intelligent connected vehicle i; |\vec{V}ⱼ(t)| denotes a velocity of the intelligent connected vehicle j at a time t; θ_{i,j}(t) denotes a driving angle between the intelligent connected vehicle i and the intelligent connected vehicle j at the time t; r_{Risk} denotes a traffic risk-related reward function; ƒ_{Risk}(ξ) denotes a traffic risk integral; Rₜₕᵣ denotes a risk threshold; and τ_{rc} denotes a duration exceeding the risk threshold; and for the traffic aggressiveness:
$${R}_{j , i} ( {t}^{′} ) = \vert {\vec{S}}_{j , i} ( {t}^{′} ) \vert exp ( - {k}_{c} \vert {\vec{V}}_{i} ( {t}^{′} ) \vert cos {θ}_{j , i} ( {t}^{′} ) )$$
$${r}_{Agg} = \{ \begin{matrix}{f}_{Agg} ( ξ ) = {\sum }_{j \neq i} {\sum }_{{t}^{′}} [ {R}_{j , i} ( {t}^{′} ) - {R}_{thr} ] {τ}_{rc} \\ ∀ {R}_{j , i} ( {t}^{′} ) ⩾ {R}_{thr} ]\end{matrix}$$
wherein, R_{j,i}(t′) denotes a traffic risk caused by the intelligent connected vehicle i toward the intelligent connected vehicle j; |\vec{S}_{j,i}(t′)| denotes a field intensity of the intelligent connected vehicle i toward the intelligent connected vehicle j; |\vec{V}ᵢ(t′)| denotes a velocity of the intelligent connected vehicle i at a time t′; θ_{j,i}(t′) denotes a driving angle between the intelligent connected vehicle j and the intelligent connected vehicle i at the time t′; r_{Agg} denotes a traffic aggressiveness-related reward function; and ƒ_{Agg}(ξ) denotes a traffic aggressiveness integral; and
the driving safety-related reward function is constructed according to the following equation:
$${r}_{Safety} = {r}_{Risk} + {r}_{Agg} .$$

7. The vehicle-road collaborative control architecture system based on the data-mechanism coupled modeling according to claim 1, wherein the data-mechanism coupled planning control component comprises: a vehicle side information processing module, a reinforcement learning primary planning control module, and an intelligent chassis secondary planning control module;
the vehicle side information processing module is configured to: enable an intelligent connected vehicle to cut a global semantic bird's-eye view based on semantic bird's-eye view information provided by the road side and ego-vehicle position sensor information, and stack a cut semantic bird's-eye view with sensor information and an intelligent chassis secondary planning control result across two consecutive frames as an input to the reinforcement learning primary planning control module;
the reinforcement learning primary planning control module is configured to: take a state quantity output by the vehicle side information processing module as an input to a reinforcement learning neural network, and output a corresponding primary planning control result, comprising steering wheel control, throttle control, and brake control, wherein
$$steering ∈ [ - 1 , 1 ]$$
$$throttle ∈ [ 0 , 1 ]$$
$$brake ∈ [ 0 , 1 ]$$
wherein, steering denotes a steering wheel control quantity; throttle denotes a throttle control quantity; brake denotes a brake control quantity; and a Beta distribution serves as an output of the reinforcement learning primary planning control module:
$$Beta = ( α , β )$$
wherein, α and β denote two parameters of the Beta distribution; and
the intelligent chassis secondary planning control module is configured to: perform intelligent chassis secondary planning control by combining the output of the reinforcement learning primary planning control module with a desired route, and output a control quantity that directly controls four-wheel torques and steering angles of the intelligent connected vehicle and is transmitted back to the reinforcement learning primary planning control module of each intelligent connected vehicle as part of the state quantity.

8. The vehicle-road collaborative control architecture system based on the data-mechanism coupled modeling according to claim 7, wherein the intelligent chassis secondary planning control module is configured to: construct a coordination and cooperation problem between intelligent chassis subsystems as an optimization problem considering a global performance indicator, and is described by the following equation:
$${min}_{{U}_{i} ( t )} {J}_{i} ( {x}_{i}^{p} , {u}_{i}^{p} , {x}_{j}^{a} , {u}_{j}^{a} ) = {λ}_{i} {J}_{i} ( {x}_{i}^{p} , {u}_{i}^{p} , {x}_{j}^{a} , {u}_{j}^{a} ) + {\sum }_{j = 1 , j \neq i}^{m} {λ}_{j} {J}_{j} ( {x}_{j}^{p} , {u}_{j}^{p} , {x}_{i}^{a} , {u}_{i}^{a} ) = {λ}_{i} {‖ {X}_{i} - {W}_{i} ‖}_{{\tilde{Q}}_{i}}^{2} + {λ}_{i} {‖ {U}_{i} ‖}_{{\tilde{R}}_{i}}^{2} + {\sum }_{j = 1 , j \neq i}^{m} [ {λ}_{j} {‖ {X}_{j} - {W}_{j} ‖}_{{\tilde{Q}}_{i}}^{2} + {λ}_{j} {‖ {U}_{j} ‖}_{{\tilde{R}}_{j}}^{2} ]$$
wherein, Uᵢ(t) denotes a control quantity of an intelligent subsystem i at a time t; Jᵢ and Jⱼ denote total cost functions of the intelligent subsystem i and an intelligent subsystem j, respectively;
$${x}_{i}^{p}$$
denotes a predicted state of the intelligent subsystem i at a future time;
$${u}_{i}^{p}$$
denotes a control quantity of the intelligent subsystem i at the future time;
$${x}_{j}^{a}$$
denotes an state of the intelligent subsystem j neighboring;
$${u}_{i}^{a}$$
denotes an assumed control quantity of the intelligent subsystem i neighboring; λᵢ denotes a coupling coefficient for cost functions between the intelligent subsystems,
$${\sum }_{i = 1}^{m} {λ}_{i} = 1 ; {X}_{i}$$
denotes a predicted state of the intelligent subsystem i; Wᵢ denotes a reference state sequence of the intelligent subsystem i; Uᵢ denotes a control quantity sequence of the intelligent subsystem i; \tilde{Q}ᵢ denotes a state weight coefficient sequence; and \tilde{R}ᵢ denotes a control weight coefficient sequence of the intelligent subsystem i;
$${J}_{i} ( {x}_{i}^{p} , {u}_{i}^{p} , {x}_{j}^{a} , {u}_{j}^{a} ) = {λ}_{i} {‖ {F}_{ii} {x}_{i} ( k ) + {G}_{ii} {U}_{i} + {\sum }_{j = 1 , j \neq i}^{m} ( {F}_{ij} {X}_{j} + {G}_{ij} {U}_{j} ) - {W}_{i} ‖}_{{Q}_{i}}^{2} + {λ}_{i} {‖ {U}_{i} ‖}_{{R}_{i}}^{2} + {\sum }_{j = 1 , j \neq i}^{m} {λ}_{j} {‖ {F}_{jj} {x}_{j} ( k ) + {G}_{jj} {U}_{j} + {\sum }_{k = 1 , k \neq j}^{m} ( {F}_{jk} {X}_{k} + {G}_{jk} {U}_{k} ) - {W}_{j} ‖}_{{Q}_{j}}^{2} + {\sum }_{j = 1 , j \neq i}^{m} {λ}_{j} {‖ {U}_{j} ‖}_{{R}_{j}}^{2} = {U}_{i}^{T} {}_{i} {U}_{i} + 2 ( {i}_{} + {}_{i} ) {U}_{i} + const$$
wherein, Fᵢᵢ, Gᵢᵢ, Fᵢⱼ, Gᵢⱼ, Fⱼⱼ, Gⱼⱼ, Fⱼₖ, and Gⱼₖ denote computation matrices, respectively; xᵢ(k) denotes a state of the intelligent subsystem i at a future time k; Xₖ denotes a state sequence of the intelligent subsystem at the future time k; Uₖ denotes a control quantity sequence of the intelligent subsystem j at the future time k;
$${U}_{i}^{T}$$
denotes a transpose matrix for the control quantity sequence of the intelligent subsystem i; const denotes a constant; and [symbol] , [symbol] , and [symbol] are respectively described by the following three equations:
$${}_{i}^{} = {λ}_{i} {G}_{ii}^{T} {Q}_{i} {G}_{ii} + {λ}_{i} {R}_{i} + {\sum }_{j = 1 , j \neq i}^{m} {λ}_{j} {G}_{ji}^{T} {Q}_{i} {G}_{ji}$$
$${}_{i} = {\sum }_{j = 1}^{m} {λ}_{j} [ {x}_{j}^{T} ( k ) {F}_{j j}^{T} - {W}_{j}^{T} ] {Q}_{j} {G}_{j i}$$
$${}_{i} = {λ}_{j} [ {\sum }_{k = 1 , k \neq i}^{m} {U}_{k}^{T} {G}_{j k}^{T} + {\sum }_{k = 1 , k \neq j}^{m} {X}_{k}^{T} {F}_{j k}^{T} ] {Q}_{j} {G}_{j i}$$
wherein, Qᵢ denotes a state weight coefficient of the intelligent subsystem i; Rᵢ denotes a control weight coefficient of the intelligent subsystem i;
$${x}_{j}^{T} ( k )$$
denotes a transpose matrix for the state sequence of the intelligent subsystem j at the future time k;
$${W}_{j}^{T}$$
denotes a transpose matrix for a reference state sequence of the intelligent subsystem j; Qⱼ denotes a state weight coefficient of the intelligent subsystem j,
$${U}_{k}^{T}$$
denotes a transpose matrix for a control sequence of the intelligent subsystem j at the future time k; and
$${X}_{k}^{T}$$
denotes a transpose matrix for the state sequence of the intelligent subsystem j at the future time k.

9. The vehicle-road collaborative control architecture system based on the data-mechanism coupled modeling according to claim 1, wherein the data-mechanism coupled evaluation component comprises: a comfort index modeling module, a neural network selection module, and a neural network parameter aggregation module;
the comfort index modeling module is configured to: take three state quantities most significantly perceived by a human, comprising lateral acceleration, yaw angular acceleration, and longitudinal acceleration, as evaluation indexes based on a degree of state variation during vehicle driving, sequentially delineate sensitivity intervals of human perception, and take a weighted sum of squares of the three state quantities as the comfort quantification index:
$${‖ δ ‖}_{2}^{2} = {\sum }_{i = 0}^{m} {ω}_{i} {{S}_{i} ( t )}^{2}$$
wherein,
$${‖ δ ‖}_{2}^{2}$$
denotes an intelligent chassis-based human comfort quantification index; Sᵢ(t) denotes the lateral acceleration, the yaw angular acceleration, and the longitudinal acceleration at a time t; ωᵢ denotes a weighting parameter for the lateral acceleration, the yaw angular acceleration, and the longitudinal acceleration; and i∈[0, m], wherein, m=3 denotes lateral, yaw angular, and longitudinal directions;
the neural network selection module is configured to: take the intelligent chassis-based human comfort quantification index as a selection criterion, and select a reinforcement learning neural network parameter corresponding to an intelligent connected vehicle with highest perceived human comfort, with a selection process described by:
$${ϕ}_{t , i}^{*} = \frac{1}{2} ( {ϕ}_{t , i} + {}_{{ϕ}_{t , {i}^{′}}}^{argmin} {‖ δ ‖}_{2}^{2} ) , \qquad i \neq {i}^{′}$$
wherein,
$${ϕ}_{t , i}^{*}$$
denotes a new neural network parameter aggregated from an intrinsic parameter φ_{t,i} of one intelligent connected vehicle and a parameter φ_{t,i′} of another intelligent connected vehicle at the time t; and
the neural network parameter aggregation module is configured to: acquire a neural network parameter of the intelligent connected vehicle via road side vehicle-to-infrastructure (V2I) communication, calculate a shared neural network parameter through parameter averaging, and distribute the shared neural network parameter to the vehicle side via V2I communication for experience sharing until a network convergence is achieved; and the parameter averaging is described by the following equation:
$${ϕ}_{m}^{*} = \frac{1}{N} {\sum }_{i} {ϕ}_{m , i}^{′}$$
wherein,
$${ϕ}_{m}^{*}$$
denotes the shared neural network parameter at a time m; N denotes a quantity of the intelligent connected vehicle; and
$${ϕ}_{m , i}^{′}$$
denotes the neural network parameter of the intelligent connected vehicle i at the time m.

10. A construction method for a vehicle-road collaborative control architecture system based on data-mechanism coupled modeling, comprising:
step 1: performing rule-guided coupled modeling: performing information processing through a road side, utilizing a field-of-view advantage of the road side to convert an image under a bird's-eye view into a semantic bird's-eye view, modeling an interaction between intelligent connected vehicles at the road side through dynamic information in the semantic bird's-eye view, transmitting safety field information and the semantic bird's-eye view to a vehicle side via vehicle-to-infrastructure (V2I) communication, constructing a safety field at the vehicle side, modeling an interaction process of the intelligent connected vehicles from a road side perspective, and performing reward function modeling in two aspects: driving expectation and driving safety;
step 2: constructing a data-mechanism coupled planning control algorithm: constructing chassis feedback-based reinforcement learning and intelligent chassis secondary planning control architecture, and performing data-mechanism coupled planning control through real-time dynamic coupling between an intelligent chassis system and a reinforcement learning algorithm, wherein the data-mechanism coupled planning control algorithm comprises: vehicle side information processing, reinforcement learning primary planning control, and intelligent chassis secondary planning control; performing vehicle side information processing; acquiring, by each of the intelligent connected vehicles, semantic bird's-eye view information from the road side via the V2I communication, and cutting a global semantic bird's-eye view based on ego-vehicle position sensor information; combining a cut semantic bird's-eye view with sensor information and an intelligent chassis secondary planning control result, and stacking three state quantities across two consecutive frames as an input for the reinforcement learning primary planning control; performing the reinforcement learning primary planning control, taking state quantities output from information processing of each of the intelligent connected vehicles as an input to a reinforcement learning neural network, and generating a corresponding primary planning control result; performing the intelligent chassis secondary planning control by combining a reinforcement learning primary planning control output with a desired route; and generating a secondary planning control output that directly controls four-wheel torques and steering angles of the intelligent connected vehicles and provides a control quantity transmitted back to a reinforcement learning primary planning control process of each of the intelligent connected vehicles as part of the state quantities;
step 3: performing data-mechanism coupled evaluation: constructing a comfort quantification index, performing coupled evaluation through a neural network selection mechanism based on a vehicle chassis mechanism model, and performing quantitative evaluation of intelligent connected vehicle control performance based on the comfort quantification index;
step 4: performing neural network selection: taking the comfort quantification index as a selection criterion, and selecting a reinforcement learning neural network parameter corresponding to the intelligent connected vehicles with highest perceived human comfort; and
step 5: performing neural network parameter aggregation: acquiring a neural network parameter of each of the intelligent connected vehicles via road side V2I communication, calculating a shared neural network parameter through parameter averaging, and distributing the shared neural network parameter to the vehicle side via the V2I communication for experience sharing until a network convergence is achieved;
wherein, in the step 1, the reward function modeling considers the two aspects: the driving expectation and the driving safety:
$$r = {r}_{expectation} + {r}_{safety}$$
wherein, r denotes a reward function; r_{expectation} denotes a driving expectation-related reward function; and r_{safety} denotes a driving safety-related reward function;
the driving expectation-related reward function comprises two aspects: lateral and longitudinal; and for a lateral driving expectation:
$$d 0 = min ( {‖ {a}_{28 , 28} - {b}_{desired route} ‖}^{2} )$$
$${r 1}_{lateral} = - {log}_{1.1} ( \vert d 0 \vert + 1 )$$
$${r 2}_{lateral} = - 10 * \vert sin ( radians ( θ ) ) \vert$$
$${r}_{lateral} = {r 1}_{lateral} + {r 2}_{lateral}$$
wherein, d0 denotes a distance from a lane centerline; a_{28,28} denotes an ego-vehicle center; b_{desired route} denotes the desired route; r1ₗₐₜₑᵣₐₗ denotes a lateral distance reward function; r2ₗₐₜₑᵣₐₗ denotes a heading angle reward function; e denotes an vehicle side heading angle deviation; and rₗₐₜₑᵣₐₗ denotes a lateral driving expectation reward function;
for a longitudinal driving expectation:
$${d}_{min} = min ( {‖ {a}_{28 , 28} - {b}_{x , y} ‖}^{2} )$$
$$x = \{ \text{} \begin{matrix}\frac{{d}_{min}}{{v}_{ego}} , & if {d}_{min} \leq 14 \\ 1 , & if {d}_{min} > 14\end{matrix} \text{}$$
$${r 1}_{longitudinal} = - 5 + \sqrt{{5}^{2} ( 1 - {( x - 1 )}^{2} )}$$
$${r 2}_{longitudinal} = - \vert {v}_{ego} - 9 \vert$$
$${r}_{longitudinal} = {r 1}_{longitudinal} + {r 2}_{longitudinal}$$
wherein, dₘᵢₙ denotes a minimum distance between autonomous vehicles; b_{x,y} denotes a surrounding-vehicle center, x denotes a collision time; v_{ego} denotes an ego-vehicle velocity; r1_{longitudinal} denotes a distance reward function; r2_{longitudinal} denotes a velocity reward function; and r_{longitudinal} denotes a longitudinal driving expectation reward function;
the driving expectation-related reward function is constructed according to the following equation:
$${r}_{expectation} = {r}_{lateral} + {r}_{longitudinal}$$
the driving safety-related reward function is calculated from two aspects of a traffic safety field of the road side: traffic safety and traffic aggressiveness; and for the traffic safety:
$${R}_{i , j} ( t ) = \vert {\vec{S}}_{i , j} ( t ) \vert exp ( - {k}_{c} \vert {\vec{V}}_{j} ( t ) \vert cos {θ}_{i , j} ( t ) )$$
$${r}_{Risk} = \{ \text{} \begin{matrix}{f}_{Risk} ( ξ ) = {\sum }_{j \neq i} {\sum }_{t} [ {R}_{i , j} ( t ) - {R}_{thr} ] {τ}_{rc} \\ ∀ {R}_{i , j} ( t ) ⩾ {R}_{thr}\end{matrix} \text{}$$
wherein, R_{i,j}(t) denotes a traffic risk; |\vec{S}_{i,j}(t)| denotes a field intensity between an intelligent connected vehicle i and an intelligent connected vehicle j; k_{c} denotes a risk perception coefficient; \vec{V}ⱼ(t)| denotes a velocity of the intelligent connected vehicle j at a time t; θ_{i,j}(t) denotes a driving angle between the intelligent connected vehicle i and the intelligent connected vehicle j at the time t; r_{Risk} denotes a traffic risk-related reward function; ƒ_{Risk}(ξ) denotes a traffic risk integral; Rₜₕᵣ denotes a risk threshold; and τ_{rc} denotes a duration exceeding the risk threshold; and for the traffic aggressiveness:
$${R}_{j , i} ( {t}^{′} ) = \vert {\vec{S}}_{j , i} ( {t}^{′} ) \vert exp ( - {k}_{c} \vert {\vec{V}}_{i} ( {t}^{′} ) \vert {cos θ}_{j , i} ( {t}^{′} ) )$$
$${r}_{Agg} = \{ \text{} \begin{matrix}{f}_{Agg} ( ξ ) = {\sum }_{j \neq i} {\sum }_{{t}^{′}} [ {R}_{j , i} ( {t}^{′} ) - {R}_{thr} ] {τ}_{rc} \\ ∀ {R}_{j , i} ( {t}^{′} ) ⩾ {R}_{thr}\end{matrix}$$
wherein, R_{j,i}(t′) denotes a traffic risk; |\vec{S}_{j,i}(t′)| denotes a field intensity between the intelligent connected vehicle j and the intelligent connected vehicle i; |\vec{V}ᵢ(t′)| denotes a velocity of the intelligent connected vehicle i at a time t′; θ_{j,i}(t′) denotes a driving angle between the intelligent connected vehicle j and the intelligent connected vehicle i at the time t′; r_{Agg} denotes a traffic aggressiveness-related reward function; and ƒ_{Agg}(ξ) denotes a traffic aggressiveness integral;
the driving safety-related reward function is constructed according to the following equation:
$${r}_{Safety} = {r}_{Risk} + {r}_{Agg} ;$$
in the step 2, the reinforcement learning primary planning control process comprises three components: steering wheel control, throttle control, and brake control:
$$steering ∈ [ - 1 , 1 ]$$
$$throttle ∈ [ 0 , 1 ]$$
$$brake ∈ [ 0 , 1 ]$$
wherein, steering denotes a steering wheel control quantity; throttle denotes a throttle control quantity; and brake denotes a brake control quantity;
a Beta distribution serves as an output of the reinforcement learning primary planning control:
$$Beta = B ( α , β )$$
wherein, α and β denote two parameters of the Beta distribution;
in the step 2, an intelligent chassis secondary planning control process is configured to construct a coordination and cooperation problem between intelligent chassis subsystems as an optimization problem considering a global performance indicator, and is described by the following equation:
$${min}_{{U}_{i} ( t )} {J}_{i} ( {x}_{i}^{p} , {u}_{i}^{p} , {x}_{j}^{a} , {u}_{j}^{a} ) = {λ}_{i} {J}_{i} ( {x}_{i}^{p} , {u}_{i}^{p} , {x}_{j}^{a} , {u}_{j}^{a} ) + {\sum }_{j = 1 , j \neq i}^{m} {λ}_{j} {J}_{j} ( {x}_{j}^{p} , {u}_{j}^{p} , {x}_{i}^{a} , {u}_{i}^{a} ) = {λ}_{i} {‖ {X}_{i} - {W}_{i} ‖}_{{\tilde{Q}}_{i}}^{2} + {λ}_{i} {‖ {U}_{i} ‖}_{{\tilde{R}}_{i}}^{2} + {\sum }_{j = 1 , j \neq i}^{m} [ {λ}_{j} {‖ {X}_{j} - {W}_{j} ‖}_{{\tilde{Q}}_{j}}^{2} + {λ}_{j} {‖ {U}_{j} ‖}_{{\tilde{R}}_{j}}^{2} ]$$
wherein, Uᵢ(t) denotes a control quantity of an intelligent subsystem i at the time t; Jᵢ denotes a total cost function of the intelligent subsystem i;
$${x}_{i}^{p}$$
denotes a predicted state of the intelligent subsystem i at a future time;
$${u}_{i}^{p}$$
denotes a control quantity of the intelligent subsystem i at the future time;
$${x}_{j}^{a}$$
denotes an assumed state of an intelligent subsystem j neighboring;
$${u}_{i}^{a}$$
denotes an assumed control quantity of the intelligent subsystem i neighboring; λᵢ denotes a coupling coefficient for cost functions between the intelligent subsystems,
$${{\sum }_{i = 1}^{m}}_{} {λ}_{i} = 1 ;$$
Xᵢ denotes a predicted state of the intelligent subsystem i; Wᵢ denotes a reference state sequence of the intelligent subsystem i; Uᵢ denotes a control quantity sequence of the intelligent subsystem i; \tilde{Q}ᵢ denotes a state weight coefficient sequence; and \tilde{R}ᵢ denotes a control weight coefficient sequence of the intelligent subsystem i;
$${J}_{i} ( {x}_{i}^{p} , {u}_{i}^{p} , {x}_{j}^{a} , {u}_{j}^{a} ) = {λ}_{i} {‖ {F}_{ii} ( k ) + {G}_{ii} {U}_{i} + {\sum }_{j = 1 , j \neq i}^{m} ( {F}_{ij} {X}_{j} + {G}_{ij} {U}_{j} ) - {W}_{i} ‖}_{{Q}_{i}}^{2} + {λ}_{i} {‖ U ‖}_{{R}_{i}}^{2} + {\sum }_{j = 1 , j \neq i}^{m} {λ}_{j} {‖ {F}_{jj} {x}_{j} ( k ) + {G}_{jj} {U}_{j} + {\sum }_{k = 1 , k \neq i}^{m} ( {F}_{jk} {X}_{k} + {G}_{jk} {U}_{k} ) - {W}_{j} ‖}_{{Q}_{i}}^{2} + {\sum }_{j = 1 , j \neq i}^{m} {λ}_{i} {‖ {U}_{j} ‖}_{{R}_{j}}^{2} = {U}_{i}^{T} {i}_{} {U}_{i} + 2 ( {i}_{} + {i}_{} ) {U}_{i} + const$$
wherein, Fᵢᵢ, Gᵢᵢ, Fᵢⱼ, Gᵢⱼ, Fⱼⱼ, Gⱼⱼ, Fⱼₖ, and Gⱼₖ denote computation matrices, respectively; xᵢ(k) denotes a state of the intelligent subsystem i at a future time k; Xₖ denotes a state sequence of the intelligent subsystem at the future time k; Uₖ denotes a control quantity sequence of the intelligent subsystem j at the future time k;
$${U}_{i}^{T}$$
denotes a transpose matrix for the control quantity sequence of the intelligent subsystem i; const denotes a constant; and [symbol] , [symbol] , and [symbol] are respectively described by the following three equations:
$${i}_{} = {λ}_{i} {G}_{ii}^{T} {Q}_{i} {G}_{ii} + {λ}_{i} {R}_{i} + {\sum }_{j = 1 , j \neq i}^{m} {λ}_{j} {G}_{ji}^{T} {Q}_{i} {G}_{ji}$$
$${i}_{} = {\sum }_{j = 1}^{m} {λ}_{j} [ {x}_{j}^{T} ( k ) {F}_{jj}^{T} - {W}_{j}^{T} ] {Q}_{j} {G}_{ji}$$
$${i}_{} = {\sum }_{j = 1}^{m} {λ}_{j} [ {\sum }_{k = 1 , k \neq i}^{m} {U}_{k}^{T} {G}_{jk}^{T} + {\sum }_{k = 1 , k \neq j}^{m} {X}_{k}^{T} {F}_{jk}^{T} ] {Q}_{j} {G}_{ji}$$
wherein, Qᵢ denotes a state weight coefficient of the intelligent subsystem i; Rᵢ denotes a control weight coefficient of the intelligent subsystem i;
$${x}_{j}^{T} ( k )$$
denotes a transpose matrix for the state sequence of the intelligent subsystem j at the future time k;
$${W}_{j}^{T}$$
denotes a transpose matrix for a reference state sequence of the intelligent subsystem j; Qⱼ denotes a state weight coefficient of the intelligent subsystem j;
$${U}_{k}^{T}$$
denotes a transpose matrix for a control sequence of the intelligent subsystem j at the future time k; and
$${X}_{k}^{T}$$
denotes a transpose matrix for the state sequence of the intelligent subsystem j at the future time k;
in the step 3, the comfort index modeling is configured to: take three state quantities most significantly perceived by a human, comprising lateral acceleration, yaw angular acceleration, and longitudinal acceleration, as evaluation indexes based on a degree of state variation during vehicle driving, sequentially delineate sensitivity intervals of human perception, and take a weighted sum of squares of the three state quantities as the comfort quantification index:
$${‖ δ ‖}_{2}^{2} = {\sum }_{i = 0}^{m} {ω}_{i} {{S}_{i} ( t )}^{2}$$
wherein,
$${‖ δ ‖}_{2}^{2}$$
denotes an intelligent chassis-based human comfort quantification index; Sᵢ(t) denotes the lateral acceleration, the yaw angular acceleration, and the longitudinal acceleration at the time t; ωᵢ denotes a weighting parameter for the lateral acceleration, the yaw angular acceleration, and the longitudinal acceleration; and i∈[0, m], wherein, m=3 denotes lateral, yaw angular, and longitudinal directions;
in the step 4, a selection process is described by:
$${ϕ}_{t , i}^{*} = \frac{1}{2} ( {ϕ}_{t , i} + {arg min}_{{ϕ}_{t , i}} {‖ δ ‖}_{2}^{2} ) , i \neq {i}^{′}$$
wherein,
$${ϕ}_{t , i}^{*}$$
denotes a new network parameter aggregated from an intrinsic parameter φ_{t,i} of one of the intelligent connected vehicles and a parameter φ_{t,i′} of another of the intelligent connected vehicles at the time t; and
in the step 5, the parameter averaging is performed according to the following equation:
$${ϕ}_{m}^{*} = \frac{1}{N} {\sum }_{i} {ϕ}_{m , i}^{′}$$
wherein,
$${ϕ}_{m}^{*}$$
denotes the shared neural network parameter at a time m; N denotes a quantity of the intelligent connected vehicles; and
$${ϕ}_{m , i}^{′}$$
denotes the neural network parameter of the intelligent connected vehicle i at the time m.
